(19) United States
(12) Patent Application Publication
(10) Pub. No.: US 2026/0181114 A1
(43) Pub. Date: Jun. 25, 2026

(54) FRAME ALIGNMENT METHOD OF DISPLAY MODULE AND DISPLAY MODULE

(71) Applicant: Shanghai Tianma Micro-electronics Co., Ltd., Shanghai (CN)

(72) Inventors: Tenggang LOU, Shanghai (CN); Ximin QI, Shanghai (CN)

(21) Appl. No.: 19/424,543

(22) Filed: Dec. 18, 2025

(30) Foreign Application Priority Data
Dec. 24, 2024 (CN) 202411929323.9

(51) Int. Cl. H04N 9/31

(52) U.S. Cl. CPC H04N 9/3185; H04N 9/3105; H04N 9/3182

(57) ABSTRACT

A display module includes display panels corresponding one-to-one to projection frames and one projection frame is a projection of a display image of one corresponding display panel to a target projection surface. The method includes: obtaining target display data sets based on projection frame features and initial image data of an image to be displayed, where each target display data set includes overlapping display data and offset display data; and, controlling the overlapping data to be transmitted to overlapping panel pixels and the offset display data to be transmitted to offset panel pixels in the corresponding display panel. The projection frame features include projection pixel information of each projection frame overlapping and/or offset with other projection frames. The overlapping display data respectively included in different target display data sets corresponds to one same frame in the image to be displayed.

### CROSS-REFERENCE TO RELATED APPLICATION

This application claims the priority of Chinese Patent Application No. 202411929323.9, filed on Dec. 24, 2024, the content of which is incorporated herein by reference in its entirety.

### TECHNICAL FIELD

The present disclosure generally relates to the field of display technology and, more particularly, relates to a frame alignment method of a display module and a display module.

### BACKGROUND

With the continuous development of display technologies, various new display technologies have emerged. Among them, one display technology is to divide an image to be displayed into different parts and display them through different display panels. The parts displayed by each display panel are combined to form a complete display image. However, the technical difficulty of this display technology is that it is difficult to control the accuracy when combining the parts displayed by each display panel to form the complete display image.

### SUMMARY

One aspect of the present disclosure provides a frame alignment method of a display module. The display module includes display panels which correspond one-to-one to projection frames, and one projection frame is a projection of a display image of one corresponding display panel to a target projection surface. The method includes: obtaining target display data sets based on projection frame features and initial image data of an image to be displayed, where each target display data set includes overlapping display data and offset display data; and controlling the overlapping data in the target display data set to be transmitted to overlapping panel pixels in the corresponding display panel, and controlling the offset display data in the target display data set to be transmitted to offset panel pixels in the corresponding display panel. The projection frame features include projection pixel information of each projection frame overlapping and/or offset with other projection frames. The target display data sets are respectively transmitted to corresponding display panels. The overlapping display data respectively included in different target display data sets corresponds to one same frame in the image to be displayed. The overlapping panel pixels in the display panel correspond to the overlapping projection pixels in the corresponding projection frame that overlap with other projection frames and the offset panel pixels in the display panel correspond to the offset projection pixels in the corresponding projection frame that are offset with at least one other projection frame.

Another aspect of the present disclosure provides a display module. The display module includes: a plurality of display panels which correspond to a plurality of projection frames one-to-one, where one projection frame is a projection of a display image of one corresponding display panel to a target projection surface; and a control module. The control module is configured to: obtain a plurality of target display data sets based on projection frame features and initial image data of an image to be displayed, where each target display data set includes overlapping display data and offset display data; control the overlapping data in the target display data set to be transmitted to overlapping panel pixels in the corresponding display panel; and control the offset display data in the target display data set to be transmitted to offset panel pixels in the corresponding display panel. The projection frame features include projection pixel information of each projection frame overlapping and/or offset with other projection frames. The plurality of target display data sets is respectively used to be transmitted to corresponding display panels. The overlapping display data respectively included in different target display data sets corresponds to one same frame in the image to be displayed. The overlapping panel pixels in the display panel correspond to the overlapping projection pixels in the corresponding projection frame that overlap with other projection frames and the offset panel pixels in the display panel correspond to the offset projection pixels in the corresponding projection frame that are offset with at least one other projection frame.

Another aspect of the present disclosure provides a display module including a plurality of display panels. A display image of one display panel is projected to a target projection surface to present a corresponding projection frame. When misalignment of at least two projection frames along a first direction on the target projection surface exceeds a preset value, overlapping panel pixels in different display panels display one same frame and the misaligned panel pixels in different display panels display a first grayscale image. The overlapping panel pixels in one display panel correspond to overlapping projection pixels in one corresponding projection frame that overlap with other projection frames, and the misaligned panel pixels in the display panel correspond to misaligned projection pixels in the corresponding projection frame that are misaligned with at least one other projection frame.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates an exemplary display module consistent with various disclosed embodiments in the present disclosure.

FIG. 2 illustrates a schematic diagram of a projection frame of an image to be displayed on a target projection surface consistent with various disclosed embodiments in the present disclosure.

FIG. 3 illustrates a flowchart of an exemplary frame alignment method of a display module consistent with various disclosed embodiments in the present disclosure.

FIG. 4 illustrates another schematic diagram of a projection frame of an image to be displayed on a target projection surface consistent with various disclosed embodiments in the present disclosure.

FIG. 5 illustrates a flowchart of another exemplary frame alignment method of a display module consistent with various disclosed embodiments in the present disclosure.

FIG. 6 illustrates a schematic diagram of a relationship between initial image data and a display image of display panels consistent with various disclosed embodiments in the present disclosure.

FIG. 7 illustrates a flowchart of another exemplary frame alignment method of a display module consistent with various disclosed embodiments in the present disclosure.

FIG. 8 illustrates another schematic diagram of a relationship between initial image data and a display image of display panels consistent with various disclosed embodiments in the present disclosure.

FIG. 9 illustrates a flowchart of another exemplary frame alignment method of a display module consistent with various disclosed embodiments in the present disclosure.

FIG. 10 illustrates a flowchart of another exemplary frame alignment method of a display module consistent with various disclosed embodiments in the present disclosure.

FIG. 11 illustrates a flowchart of another exemplary frame alignment method of a display module consistent with various disclosed embodiments in the present disclosure.

FIG. 12 illustrates another schematic diagram of a projection frame of an image to be displayed on a target projection surface consistent with various disclosed embodiments in the present disclosure.

FIG. 13 illustrates another schematic diagram of a relationship between initial image data and a display image of display panels consistent with various disclosed embodiments in the present disclosure.

FIG. 14 illustrates a flowchart of another exemplary frame alignment method of a display module consistent with various disclosed embodiments in the present disclosure.

FIG. 15 illustrates another schematic diagram of a relationship between initial image data and a display image of display panels consistent with various disclosed embodiments in the present disclosure.

FIG. 16 illustrates a flowchart of another exemplary frame alignment method of a display module consistent with various disclosed embodiments in the present disclosure.

FIG. 17 illustrates another schematic diagram of a relationship between initial image data and a display image of display panels consistent with various disclosed embodiments in the present disclosure.

FIG. 18 illustrates a flowchart of another exemplary frame alignment method of a display module consistent with various disclosed embodiments in the present disclosure.

FIG. 19 illustrates another schematic diagram of a projection frame of an image to be displayed on a target projection surface consistent with various disclosed embodiments in the present disclosure.

FIG. 20 illustrates another schematic diagram of a relationship between initial image data and a display image of display panels consistent with various disclosed embodiments in the present disclosure.

FIG. 21 illustrates a flowchart of another exemplary frame alignment method of a display module consistent with various disclosed embodiments in the present disclosure.

FIG. 22 illustrates a flowchart of another exemplary frame alignment method of a display module consistent with various disclosed embodiments in the present disclosure.

FIG. 23 illustrates another schematic diagram of a relationship between initial image data and a display image of display panels consistent with various disclosed embodiments in the present disclosure.

FIG. 24 illustrates a flowchart of another exemplary frame alignment method of a display module consistent with various disclosed embodiments in the present disclosure.

FIG. 25 illustrates a flowchart of another exemplary frame alignment method of a display module consistent with various disclosed embodiments in the present disclosure.

FIG. 26 illustrates a flowchart of another exemplary frame alignment method of a display module consistent with various disclosed embodiments in the present disclosure.

FIG. 27 illustrates a flowchart of another exemplary frame alignment method of a display module consistent with various disclosed embodiments in the present disclosure.

FIG. 28 illustrates a flowchart of another exemplary frame alignment method of a display module consistent with various disclosed embodiments in the present disclosure.

FIG. 29 illustrates a flowchart of another exemplary frame alignment method of a display module consistent with various disclosed embodiments in the present disclosure.

FIG. 30 illustrates a flowchart of another exemplary frame alignment method of a display module consistent with various disclosed embodiments in the present disclosure.

FIG. 31 illustrates a flowchart of another exemplary frame alignment method of a display module consistent with various disclosed embodiments in the present disclosure.

FIG. 32 illustrates an exemplary display module consistent with various disclosed embodiments in the present disclosure.

### DETAILED DESCRIPTION

Reference will now be made in detail to exemplary embodiments of the disclosure, which are illustrated in the accompanying drawings. Hereinafter, embodiments consistent with the disclosure will be described with reference to drawings. In the drawings, the shape and size may be exaggerated, distorted, or simplified for clarity. Wherever possible, the same reference numbers will be used throughout the drawings to refer to the same or like parts, and a detailed description thereof may be omitted. Further, in the present disclosure, the disclosed embodiments and the features of the disclosed embodiments may be combined under conditions without conflicts. It is apparent that the embodiments described are some but not all of the embodiments of the present disclosure. Based on the disclosed embodiments, those ordinarily skilled in the art may derive other embodiments consistent with the present disclosure, all of which are within the scope of the present disclosure.

Moreover, the present disclosure is described with reference to schematic diagrams. For the convenience of descriptions of the embodiments, the cross-sectional views illustrating the device structures may not follow the common proportion and may be partially exaggerated. Besides, those schematic diagrams are merely examples, and not intended to limit the scope of the disclosure. Furthermore, a three-dimensional (3D) size including length, width, and depth should be considered during practical fabrication.

In the present disclosure, terms such as “center”, “longitudinal”, “lateral”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial”, “circumferential”, etc., indicate orientations or positional relationships based on the orientations or positional relationships shown in the accompanying drawings, and are only for the convenience of describing the present disclosure and simplifying the description, and do not indicate or imply that the device or element referred to must have a specific orientation, be constructed and operated in a specific orientation, and therefore should not be understood as limiting the present disclosure.

In the present disclosure, relational terms such as first and second are only used to distinguish one entity or operation from another entity or operation, and do not necessarily require or imply any actual relationship between these entities or operations or order. Moreover, the terms “including”, “comprising” or any other variants thereof are intended to cover non-exclusive inclusion, such that a process, method, article, or device that may include a series of elements may include not only those elements, but also those that are not explicitly listed or also include elements inherent to this process, method, article or equipment. If there are no more restrictions, the elements defined by the sentence “including . . . ” do not exclude the existence of other same elements in the process, method, article, or equipment that may include the elements.

It should be understood that when describing the structure of a component, when a layer or region is referred to as being “on” or “above” another layer or another region, the layer or region may be directly on the other layer or region, or indirectly on the other layer or region, for example, layers/components between the layer or region and another layer or another region. And, for example, when the component is reversed, the layer or region may be “below” or “under” the other layer or region. In the present disclosure, the term “electrical connection” refers to that two components are directly electrically connected with each other, or the two components are electrically connected via one or more other components.

In the present disclosure, unless otherwise clearly specified and limited, the terms “installed”, “connected”, “fixed” and the like appear, should be understood in a broad sense. For example, it can be a fixed connection, a detachable connection, or an integrated connection; it can be a mechanical connection or an electrical connection; it can be a direct connection or an indirect connection through an intermediate medium, it can be the internal connection of two elements or the interaction relationship between two elements, unless otherwise clearly defined. For those skilled in the art, the specific meanings of the above terms in the present disclosure can be understood according to the specific circumstances.

In the present disclosure, when an element is referred to as being “fixed to” or “disposed on” another element, it may be directly on the other element or there may be an intermediate element. When an element is considered to be “connected to” another element, it may be directly connected to the other element or there may be an intermediate element at the same time. If present, the terms “vertical”, “horizontal”, “upper”, “lower”, “left”, “right” and similar expressions are for illustrative purposes only and are not intended to be the only embodiment.

In the present disclosure, it should be understood that the words “substantially”, “approximately”, “approximately”, “about”, “roughly”, “substantially”, etc. described in the claims and embodiments of the present disclosure refer to what can be generally recognized within a reasonable process operation range or tolerance range, rather than an exact value.

It should be understood that although the terms first, second, etc. may be used to describe parts, leads, etc. in the embodiments of the present disclosure, these should not be limited to these terms. These terms are only used to distinguish display panels, etc. from each other. For example, without departing from the scope of the embodiments of the present disclosure, a first color display panel may also be referred to as a second color display panel, and similarly, a second color display panel may also be referred to as a first color display panel.

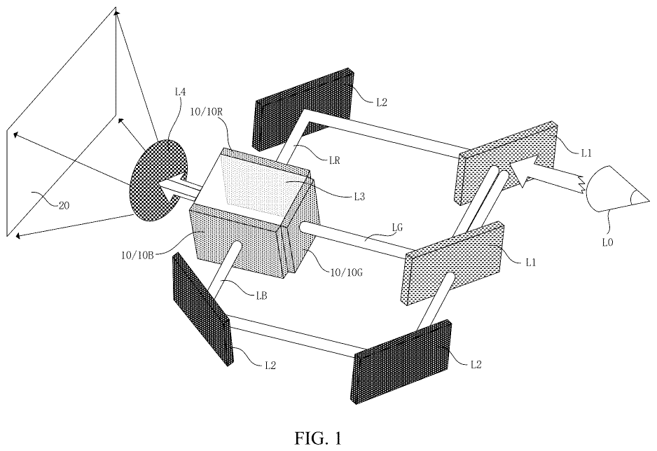

FIG. 1 shows a display module consistent with various embodiments of the present disclosure. As shown in FIG. 1, the display module 01 may include multiple display panels 10, and each display panel 10 may correspond to a plurality of projection frames. One projection frame may be a display image projection from one corresponding display panel 10 onto a target projection surface 20. When displaying an image to be displayed, the display module 01 may divide the image to be displayed into different portions, and each portion may be displayed separately on the multiple display panels 10 included in the display module 01. In other words, each of the multiple display panels 10 of the display module 01 may display different portions of the image to be displayed, and each of the displayed portions may be projected onto the target projection surface 20, thereby presenting the image to be displayed on the target projection surface 20.

As shown in FIG. 1, the display module 01 may include a red display panel 10R for displaying red images, a green display panel 10G for displaying green images, and a blue display panel 10B for displaying blue images. The pixels in the red display panel 10R may emit red light, the pixels in the green display panel 10G may emit green light, and the pixels in the blue display panel 10B may emit blue light. The image to be displayed may be achieved by controlling the brightness of pixels of different colors. For example, in one embodiment, the image to be displayed may be divided into red, blue, and green portions. The red portion may be displayed using the red display panel 10R to create a red display image, the green portion may be displayed using the green display panel 10G to create a green display image, and the blue portion may be displayed using the blue display panel 10B to create a blue display image. The red, green, and blue display images may be projected onto the target projection surface 20, respectively, to produce a red projection frame, a green projection frame, and a blue projection frame. The red, green, and blue projection frames may then be mixed on the target projection surface 20 to display the image to be displayed.

The display module 01 provided in this embodiment of the present disclosure may be a projection module such as a 3LCD projector, or a display module 01 for implementing holographic displays.

For illustration, a 3LCD projector is used as an example. As shown in FIG. 1, the 3LCD projector may include three independent LCD display panels 10, that is, a red display panel 10R, a green display panel 10G, and a blue display panel 10B. Each LCD display panel 10 may include a plurality of pixels. White light emitted by a light source L0 may be split by a beam splitter L1 into three colors: red light LR, green light LG, and blue light LB. A reflector L2 may allow the red light LR to enter the red display panel 10R, the green light LG to enter the green display panel 10G, and the blue light LB to enter the blue display panel 10B. The plurality of pixels on each LCD display panel 10 may be precisely controlled to allow different amounts of light to pass through, thereby modulating the light. A monochrome image transmitted through each LCD display panel 10 may pass through a specialized prism L3, where it is combined to form a full-color image. The composite image produced by the prism L3 may be processed and magnified by a lens set L4, ultimately appearing on the target projection frame to create a viewable image.

In the present embodiment, the display module 01 may include the target projection surface 20. For example, the display module 01 may include a target projection surface 20 such as a projector screen. In some other embodiments, the display module 01 may not include a target projection surface 20. Users may select an appropriate target projection surface 20 based on their needs. For example, a white wall may be used as the target projection surface 20.

It should also be noted that when the chromaticity of the image to be displayed is obtained by mixing red, green, and blue light, the image data corresponding to any pixel in the image to be displayed may include the red, green, and blue grayscale values corresponding to that pixel. Therefore, dividing the image to be displayed into red, blue, and green portions may include separately obtaining the red, green, and blue grayscale values for each pixel in the image to be displayed. The data voltages corresponding to the red grayscale values may be transmitted to the red display panel 10R, causing the red display panel 10R to display a red image. The data voltages corresponding to the green grayscale values may be transmitted to the green display panel 10G, causing the green display panel 10G to display a green image. The data voltages corresponding to the blue grayscale values may be transmitted to the blue display panel 10B, causing the blue display panel 10B to display a blue image.

It can be understood that one pixel in the image may include three sub-pixels of different colors: red, green, and blue. The luminance corresponding to each of these three sub-pixels may determine the brightness and chromaticity of the pixel. However, since the red display panel 10R may only include units capable of emitting red light, the light-emitting units in the red display panel 10R may be denoted as panel pixels. It can be understood that the red light emitted by one panel pixel in the red display panel 10R actually corresponds to the red grayscale corresponding to one pixel in the image to be displayed, that is, to the red sub-pixel of the pixel in the image to be displayed. Accordingly, the light-emitting units in the green display panel 10G may be denoted as panel pixels, and the light-emitting units in the blue display panel 10B may be denoted as panel pixels.

Since the smallest controllable units of the displayed image presented by the display panel 10 corresponds to the pixels included in the display panel 10, and the projection frame is actually the result of projecting the displayed image onto the target projection surface 20, the light-emitting units in the projection frame corresponding to the pixels of the display panel 10 may be denoted as projection pixels.

To ensure a clear display of the image to be displayed on the target projection surface 20, each projection frame may need to be projected at a predetermined position. Otherwise, the image to be displayed on the target projection surface 20 may be blurred. When the position of any display panel 10 changes, the position of the corresponding projection frame on the target projection surface 20 may also change. Therefore, to ensure that the image to be displayed is able to be clearly displayed on the target projection surface 20, each display panel 10 may need to be located at a preset position.

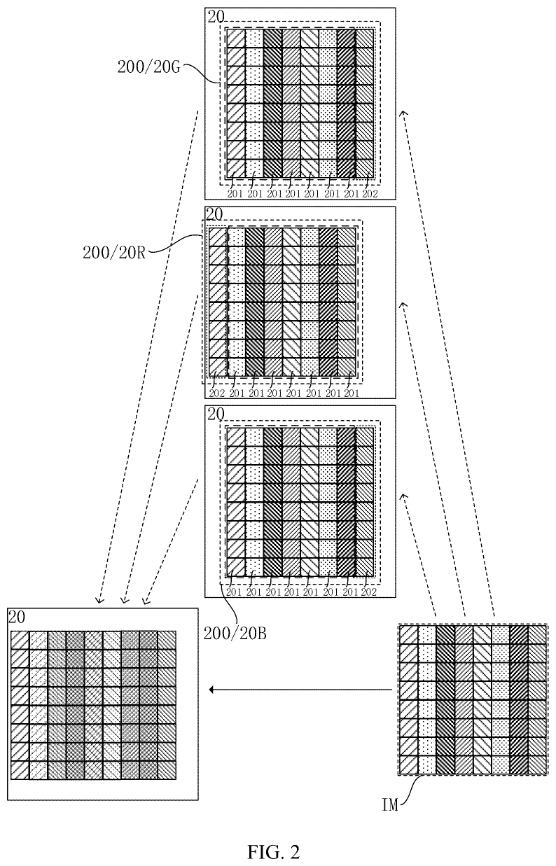

FIG. 2 is a schematic diagram of a projection frame of the image to be displayed on the target projection surface, according to one embodiment of the present disclosure.

For example, in one embodiment, an image corresponding to a first column of pixels in the image to be displayed may be displayed on a first column of pixels in the red display panel 10R, a first column of pixels in the green display panel 10G, and a first row and first column of pixels in the blue display panel 10B. Assuming that the position of the red display panel 10R changes relative to the preset position, as shown in FIG. 2, the first column of pixels in the red projection frame, the first column of pixels in the green projection frame, and the first column of pixels in the blue projection frame may be offset on the target projection surface 20, preventing the red projection frame from being properly mixed with the green projection frame and the blue projection frame to produce the first column of the to-be-displayed image IM. Consequently, a blurred image may appear on the target projection surface 20.

It should be noted that the multiple squares arranged in a matrix in the to-be-displayed image IM in FIG. 2 represent multiple pixels in the to-be-displayed image IM, and the multiple squares arranged in a matrix in each projection frame 200 on the target projection surface 20 represent projection pixels. Further, different fill patterns in different squares represent different grayscale values in those squares.

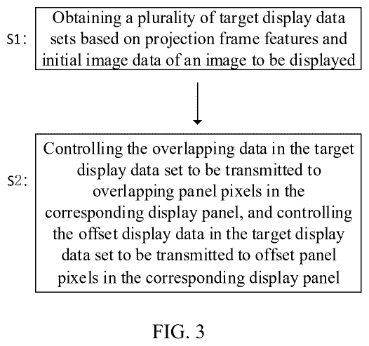

FIG. 3 is a flow chart of a frame alignment method of a display module provided in an embodiment of the present disclosure.

To at least partially alleviate the above problem, one embodiment of the present disclosure provides a frame alignment method for a display module 01. As shown in FIG. 3, in one embodiment, the method may include S1 and S2.

At S1, based on projection frame features and initial image data of an image to be displayed, multiple target display data sets may be obtained.

The projection frame features may include information about overlapping and/or misalignment of projection pixels in each projection frame 200 with other projection frames 200, in other words, information about the overlap and/or misalignment of projection pixels in each projection frame 200 with projection pixels in other projection frames 200. Assuming that the target projection surface 20 may include N projection frames 200, the projection frame features may include information about the overlap and/or misalignment of projection pixels in each of the N projection frames 200.

It should be noted that multiple projection pixels used to represent one same pixel in the to-be-displayed image IM may overlap to achieve color mixing, or they may be spaced a predetermined distance apart to achieve color mixing. For example, when multiple projection pixels representing the same pixel in the image IM to be displayed overlap with each other to achieve color mixing, the different projection pixels representing the same pixel in the image IM to be displayed may be considered to overlap. When the different projection pixels representing the same pixel in the image IM to be displayed are separated, they may be considered to be offset. For example, when the multiple projection pixels representing the same pixel in the image IM to be displayed are separated by a preset distance to achieve color mixing, the different projection pixels representing the same pixel in the image IM to be displayed may be considered to overlap if the distance between the different projection pixels is less than or equal to a preset distance; or the different projection pixels representing the same pixel in the image IM to be displayed are considered to be offset if the distance between the different projection pixels is larger than the preset distance. This embodiment of the present disclosure will use the example of the multiple projection pixels representing the same pixel in the image IM to be displayed overlapping to achieve color mixing as an example for illustration.

Projection pixels in one projection frame 200 that overlap with all other projection frames 200 may be denoted as overlapping projection pixels, and projection pixels in one projection frame 200 that do not overlap with at least one of the other projection frames 200 may be denoted as offset projection pixels. The projection frame features may include information about overlapping and offset projection pixels in each projection frame 200.

For example, as shown in FIG. 1 and FIG. 2, the target projection surface 20 may include a red projection frame 20R, a green projection frame 20G, and a blue projection frame 20B. The projection frame features may include information such as the overlapping pixel columns and rows of the red projection frame 20R and the green projection frame 20G, the overlapping pixel columns and rows of the red projection frame 20R and the blue projection frame 20B, or the overlapping pixel columns and rows of the green projection frame 20G and the blue projection frame 20B. And/or, the projection frame features may include information such as the offset pixel columns and rows of the red projection frame 20R and the green projection frame 20G, the offset pixel columns and rows of the red projection frame 20R and the blue projection frame 20B, and the offset pixel columns and rows of the green projection frame 20G and the blue projection frame 20B. In the following, the embodiments where there are overlapping and offset pixel columns in projection frames 200 of different colors and pixel rows in projection frames 200 of different colors overlap, will be used as an example to illustrate the present disclosure.

As shown in FIG. 2, for example, based on the projection frame features, it may be concluded that the second through eighth pixel columns in the red projection frame 20R overlap with the first through seventh pixel columns in the green projection frame 20G and the first through seventh pixel columns in the blue projection frame 20B. Further, the first pixel column in the red projection frame 20R may not overlap with either the green projection frame 20G or the blue projection frame 20B, and the eighth pixel column in the green projection frame 20G and the eighth pixel column in the blue projection frame 20B may not overlap with the red projection frame 20R. The projection pixels in the 2nd through 8th pixel columns of the red projection frame 20R, the projection pixels in the 1st through 7th pixel columns of the green projection frame 20G, and the projection pixels in the 1st through 7th pixel columns of the blue projection frame 20B may all be considered as overlapping projection pixels 201. The projection pixels in the 1st pixel column of the red projection frame 20R, the projection pixels in the 8th pixel column of the green projection frame 20G, and the projection pixels in the 8th pixel column of the blue projection frame 20B may all be considered as offset projection pixels 202.

The multiple target display data sets may be transmitted to the corresponding display panels 10 respectively. That is, different display panels 10 may receive target data from different target data sets. The target data in the target data sets may include data voltages in the form of analog signals or grayscale value data in the form of digital signals. The target data sets may be derived from the initial image data. Deriving the target data sets from the initial image data may at least include obtaining the display data to be received by each display panel 10 from the initial image data.

Each target display data set may include overlapping display data and offset display data. The overlapping display data included in different target display data sets may correspond to the same image in the to-be-displayed image IM. That is, the overlapping display data in each target display data set may be obtained according to the initial image data corresponding to the same portion of the to-be-displayed image IM; and the offset display data in each target display data set may be obtained according to the initial image data corresponding to another portion of the to-be-displayed image IM.

Further, when deriving the multiple target display data sets, which data in the initial image data is used to generate the overlapping display data and which data in the initial image data is used to generate the offset display data may be determined based on the projection frame features.

For example, as shown in FIG. 2, the red projection frame 20R, the green projection frame 20G, and the blue projection frame 20B each may have seven pixel columns consisting of overlapping projection pixels 201 and one pixel column consisting of offset projection pixels 202. Therefore, the overlapping display data corresponding to each display panel 10 may be derived based on the image data of the seven adjacent pixel columns in the initial image data, and the offset display data corresponding to each display panel 10 may be derived based on the image data of another pixel column in the initial image data.

At S2, the overlapping data in the target display data sets may be controlled to be transmitted to overlapping panel pixels 101 in the corresponding display panels 10, and the offset display data in the target display data sets may be controlled to be transmitted to offset panel pixels 102 in the corresponding display panels 10.

The overlapping panel pixels 101 in the display panels 10 may correspond to the overlapping projection pixels 201 in the projection frames 200 that overlap with other projection frames 200, and the offset panel pixels 102 in the display panels 10 may correspond to the offset projection pixels 202 in the projection frames 200 that are offset with at least one other projection frame 200. One projection frame 200 may be obtained by projecting the display screen of one display panel 10 onto the target projection surface 20. Therefore, when the projection frame 200 may include overlapping projection pixels 201, a portion of the panel pixels in the display panel 10 corresponding to the projection frame 200 may be defined as overlapping panel pixels 101, and these overlapping panel pixels 101 may be displayed and projected to obtain the overlapping projection pixels 201 in the projection frame 200. When the projection frame 200 may include offset projection pixels 202, a portion of the panel pixels in the display panel 10 corresponding to the projection frame 200 may be defined as offset panel pixels 102, and these offset panel pixels 102 may be displayed and projected to obtain the offset projection pixels 202 in the projection frame 200.

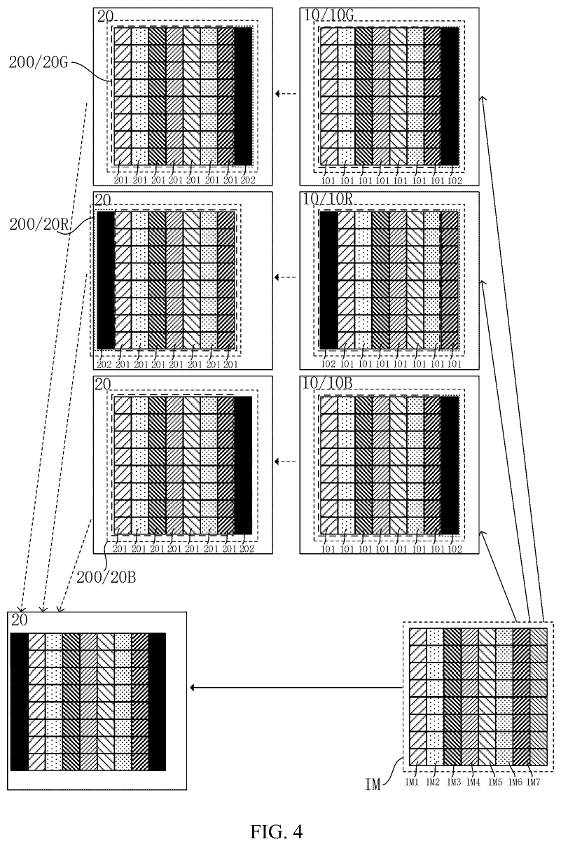

FIG. 4 is a schematic diagram of projection frames of an image to be displayed on a target projection surface, according to one embodiment of the present disclosure.

For example, as shown in FIG. 4, in one embodiment, the projection pixels in the 2nd through 8th pixel columns of the red projection frame 20R, the projection pixels in the 1 st through 7th pixel columns of the green projection frame 20G, and the projection pixels in the 1 st through 7th pixel columns of the blue projection frame 20B may be overlapping projection pixels 201. The projection pixels in the 1st pixel column of the red projection frame 20R, the projection pixels in the 8th pixel column of the green projection frame 20G, and the projection pixels in the 8th pixel column of the blue projection frame 20B may be offset projection pixels 202. For example, the 1st to 8th pixel columns in the red projection frame 20R may correspond to the 1st to 8th pixel columns in the red display panel 10R, the 1st to 8th pixel columns in the green projection frame 20G may correspond to the 1st to 8th pixel columns in the green display panel 10G, and the 1st to 8th pixel columns in the blue projection frame 20B may correspond to the 1st to 8th pixel columns in the blue display panel 10B. Then correspondingly, the panel pixels in the 2nd through 8th pixel columns of the red display panel 10R, the panel pixels in the 1 st through 7th pixel columns of the green display panel 10G, and the panel pixels in the 1st through 7th pixel columns of the blue display panel 10B may be overlapping panel pixels 101. The panel pixels in the 1st pixel column of the red display panel 10R, the panel pixels in the 8th pixel column of the green display panel 10G, and the panel pixels in the 8th pixel column of the blue display panel 10B may be offset panel pixels 102.

By transmitting the overlapping data in the target display data sets to the overlapping panel pixels 101 in the corresponding display panels 10, the overlapping panel pixels 101 in each display panel 10 may display the corresponding same portion of the image IM to be displayed. Therefore, the overlapping projection pixels 201 in each projection frame 200 may display the corresponding same portion of the image IM to be displayed, thus resolving the issue of blurring of the image IM when displayed on the target projection surface 20.

For example, as shown in FIG. 4, the red projection frame 20R, the green projection frame 20G, and the blue projection frame 20B may each have seven pixel columns consisting of overlapping projection pixels 201 and one pixel column consisting of offset projection pixels 202. The overlapping display data received by the overlapping panel pixels 101 in the red display panel 10R, the green display panel 10G, and the blue display panel 10B may be derived from the initial image data corresponding to the same seven adjacent columns of pixels IM1-IM7 in the to-be-displayed image IM. Therefore, the overlapping panel pixels 101 in the red display panel 10R, the green display panel 10G, and the blue display panel 10B may be used to display the images corresponding to the seven adjacent pixel columns in the to-be-displayed image IM. Therefore, the overlapping projection pixels 201 in the red projection frame 20R, the green projection frame 20G, and the blue projection frame 20B may be used to display the images corresponding to the seven adjacent columns of pixels in the to-be-displayed image IM.

The offset display data may be related to the to-be-displayed image IM or may be unrelated to the to-be-displayed image IM. For example, regardless of how the to-be-displayed image IM changes, the offset display data received by the different offset panel pixels 102 in the red display panel 10R may be identical, the offset display data received by the different offset panel pixels 102 in the green display panel 10G may be identical, and the offset display data received by the different offset panel pixels 102 in the blue display panel 10B may be identical.

In some embodiments, the offset display data received by the different display panels 10 may be used to make the offset panel pixels 102 in the display panels 10 to all appear black.

In some other embodiments, the offset display data received by different display panels 10 may make the offset panel pixels 102 in the display panels 10 appear in corresponding colors. For example, the offset display data received by the red display panel 10R may make the offset panel pixels 102 in the display panel 10 appear red, the offset display data received by the green display panel 10G may make the offset panel pixels 102 in the display panel 10 appear green, and the offset display data received by the blue display panel 10B may make the offset panel pixels 102 in the display panel 10 appear blue. The brightness of one offset panel pixel 102 may be the same as or similar to the brightness of its adjacent overlapping panel pixel 101. A shown in FIG. 4, the offset display data received by the red display panel 10R may cause a leftmost offset panel pixel 102 in the red display panel 10R to display a red color with the same brightness as the pixels in the second column from the left (the overlapping panel pixels 101). The offset display data received by the green display panel 10G may cause a rightmost offset panel pixel 102 in the green display panel 10G to display a green color with the same brightness as the pixels in the second column from the right (the overlapping panel pixels 101). The offset display data received by the blue display panel 10B may cause a rightmost offset panel pixel 102 in the blue display panel 10B to display a blue color with the same brightness as the pixels in the second column from the right (the overlapping panel pixels 101).

A signal processor included in the display module 01 may process the image signals it receives, for example, by decoding, scaling, or color correction. The image data obtained after decoding the image signals by the signal processor may be the initial image data described in the embodiments of the present application.

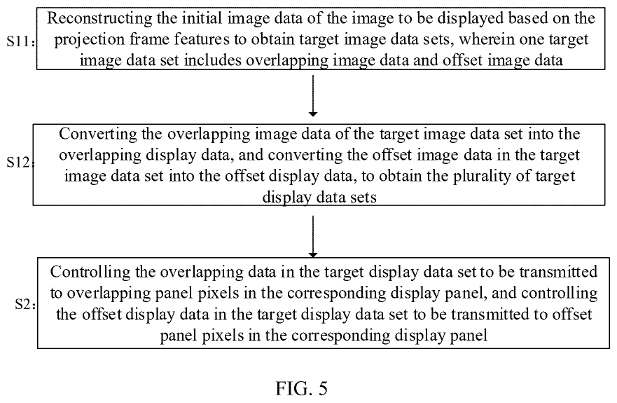

FIG. 5 is a flow chart of a frame alignment method of a display module provided by another embodiment of the present disclosure.

In another embodiment shown in FIG. 5, based on the projected image features and the initial image data of the to-be-displayed image IM, obtaining the multiple target display data sets in S1 may include S11 and S12.

At S11, based on the projected image features, the initial image data of the to-be-displayed image IM may be reconstructed to obtain the target image data sets.

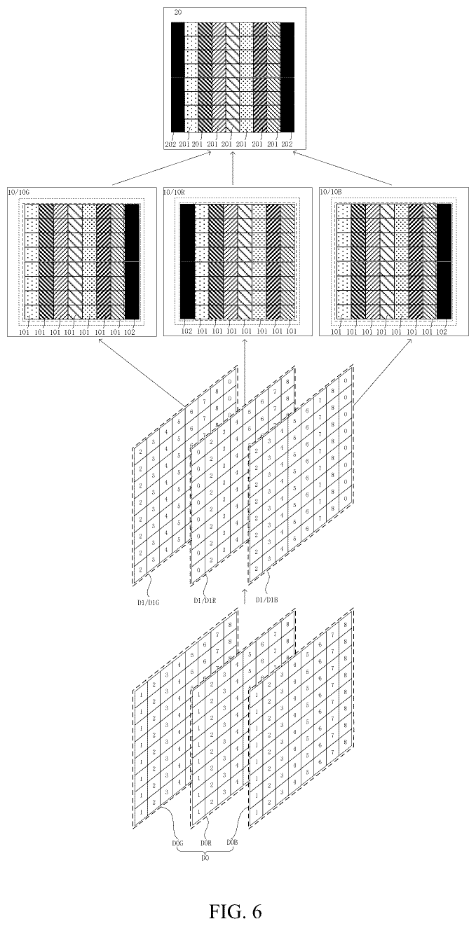

FIG. 6 is a schematic diagram of the relationship between the initial image data and the display images of the display panels in accordance with an embodiment of the present disclosure.

As shown in FIG. 6, in one embodiment, the pixel grayscales included in the image data may be viewed as data in a matrix form. Reconstructing the initial image data DO to obtain the target image data sets D1 may be understood as reconstructing the pixel grayscale matrix corresponding to the initial image data DO, including adjusting the coordinates and/or grayscale values corresponding to the pixel grayscales of the initial image data DO, to ultimately obtain the target image data sets D1. The target image data sets D1 may include overlapping image data and offset image data. The overlapping image data may correspond to images that are able to be displayed by the overlapping panel pixels 101 in each display panel 10 and presented by the overlapping projection pixels 201 of the projection frame 200. The offset image data may correspond to images that are able to be displayed by the offset panel pixels 102 in each display panel 10 and presented by the offset projection pixels 202 of the projection frame 200.

It should be noted that the initial image data DO may be considered to include the multiple initial image data sets, where the initial image data in each initial image data set corresponds to the image data to be displayed by a corresponding display panel 10. For example, when display module 01 may include the red display panel 10R, the green display panel 10G, and the blue display panel 10B, the initial image data DO may be considered to include the red initial image data set DOR, the green initial image data set DOG, and the blue initial image data set DOB. The initial image data in the red initial image data set DOR may correspond to the red image, the initial image data in the green initial image data set DOG may correspond to the green image, and the initial image data in the blue initial image data set DOB may correspond to the blue image.

The target image data sets D1 may have a one-to-one correspondence with the target display data sets. For example, when the display module 01 may include three display panels 10 each of which receives display data from different target display data sets, that is, when the three target data sets correspond one-to-one to the three display panels 10, the three target image data sets D1 may be derived from initial image data DO, and each of these three target image data sets D1 may corresponds to one of the three target display data sets. For example, when the three display panels included in display module 01 are the red display panel 10R, the green display panel 10G, and the blue display panel 10B, the red target image data set DIR, the green target image data set DIG, and the blue target image data set D1B may be generated from the initial image data DO. The display data in the target display data sets derived from the red target image data set DIR, the green target image data set DIG, and the blue target image data set DIB may be transmitted to the red display panel 10R, the green display panel 10G, and the blue display panel 10B, respectively.

Since the image corresponding to the overlapping image data in target image data set D1 needs to be displayed by the overlapping panel pixels 101 and presented by the overlapping projection pixels 201, which image data in the image data is to be used as overlapping image data and which image data is to be used as offset image data may be determined based on the projected image features.

At S12, the overlapping image data in the target image data sets D1 may be converted into overlapping display data, and the offset image data in the target image data sets D1 may be converted into offset display data, thereby obtaining the target display data sets.

The image data in the target image data sets D1 may be converted into the display data recognizable by the display panels 10, thereby obtaining the target display data sets. The overlapping image data in the target image data sets D1 may then be converted into the overlapping display data, and the offset image data may be converted into the offset display data. The display data in the target display data sets may include overlapping display data. The overlapping display data may be transmitted to the overlapping panel pixels 101 in the display panels 10 to drive the overlapping panel pixels 101 for display and is displayed through the overlapping projection pixels 201 of the projection frame 200. The overlapping image data in the target image data set D1 may correspond to the overlapping display data. Accordingly, the offset image data in the target image data sets D1 may correspond to the offset display data.

After the target image data sets D1 obtained by the signal processor processing the image signal are transmitted to the driver IC of display module 01, the driver IC of display module 01 may convert the image data in target image data sets D1 into display data that is able to be recognized by display panels 10. That is, in the frame alignment method provided in this embodiment, the driver IC of display module 01 may convert the target image data sets D1 into target display data sets.

In this embodiment, before the image data is converted into the display data, the initial image data DO may be processed based on the projected image features to obtain the target image data sets D1. The image data in target image data sets D1 may include the overlapping image data corresponding to the overlapping projection pixels 201 in display panels 10 and the offset image data corresponding to the offset projection pixels 202 in display panels 10. When converting the image data into display data, the projection frame features may no longer need to be considered. Therefore, the driver IC of display module 01 may maintain its original computing power.

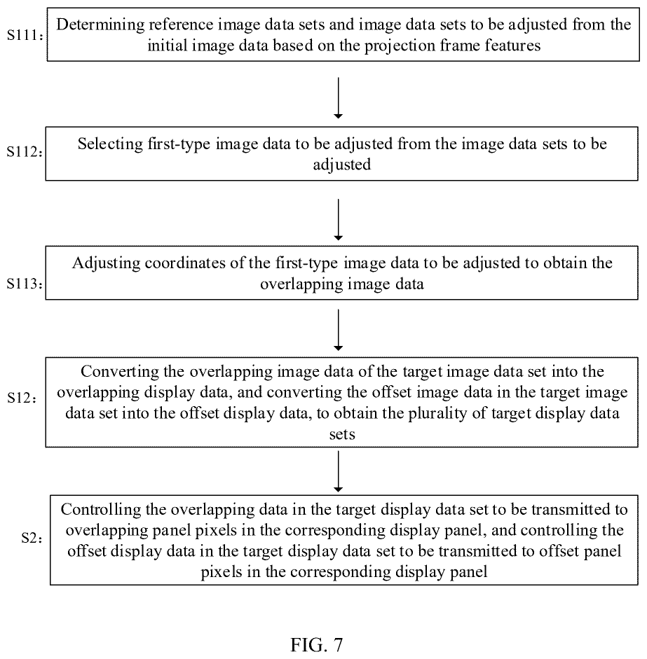

FIG. 7 is a schematic flow chart of a frame alignment method of a display module provided by another embodiment of the present disclosure. In one embodiment, as shown in FIG. 7, based on the projection frame features, reconstructing the initial image data DO of the to-be-displayed image IM to obtain the target image data sets D1 in S11 may include S111 to S113.

At S111, based on the projection frame features, determine the reference image data set and the target image data sets from the multiple initial image data DO.

The reference image data sets may include the overlapping image data.

In this embodiment, since different portions of the to-be-displayed image IM are displayed on different display panels 10 of the display module 01, the initial image data DO may be considered to include the multiple initial image data sets DO, and the images corresponding to the image data in different initial image data sets DO may be displayed on different display panels 10. Therefore, the reference image data sets and the target image data sets may be different initial image data sets DO.

Based on the projection frame features, the overlapping image data and offset image data may be determined in the reference image data sets. The overlapping image data in the reference image data sets may be converted into the overlapping display data to be received by the display panels 10 corresponding to the reference image data sets, and the corresponding image may be displayed using the overlapping projection pixels 201. The offset image data in the offset image data sets may be converted into the offset display data to be received by the display panels 10 corresponding to the reference image data sets, and the corresponding image may be displayed using the offset projection pixels 202.

The coordinates of the pixel grayscales represented by the image data included in the reference image data sets may not be adjusted. The coordinates of the overlapping image data in the reference image data sets may correspond to the overlapping panel pixels 101 in the display panels 10, such that the overlapping display data obtained by converting the overlapping image data may be transmitted to the corresponding overlapping panel pixels 101 to control the luminous brightness of the overlapping panel pixels 101. The coordinates of the offset image data in the reference image data sets may correspond to the offset panel pixels 102 in the display panel 10, such that the offset display data obtained by converting the offset image data may be transmitted to the corresponding offset panel pixels 102 to control the luminous brightness of the offset panel pixels 102.

S112: selecting a first-type image data to be adjusted from an image data set to be adjusted.

The first-type image data to be adjusted and the overlapping image data in the reference image data sets may correspond to a same frame in the to-be-displayed image IM.

Therefore, based on the overlapping image data in the reference image data sets, the first-type image data to be adjusted may be selected from the initial image data sets D0 to be adjusted. The first-type image data to be adjusted and the overlapping image data in the reference image data sets may correspond to one same frame in the to-be-displayed image IM.

In this embodiment, a portion of the to-be-displayed image IM may be selected to be displayed using the overlapping projection pixels 201 of each projection frame 200, ultimately clearly displaying this portion on the target projection surface 20. Therefore, the first-type image data to be adjusted selected from the image data sets to be adjusted may be understood as the image data used by the display panels 10 corresponding to the image data set to be adjusted to display this portion of the image.

S113: adjusting the coordinates of the first-type image data to be adjusted to obtain the overlapping image data.

The coordinates of the first-type image data to be adjusted may be adjusted to obtain the overlapping image data. The adjusted coordinates of the first-type image data to be adjusted may correspond to the coordinates of the overlapping panel pixels 101 in the display panels 10. Therefore, the overlapping display data obtained from the first-type image data to be adjusted may be converted. The overlapping display data may then be transmitted to the corresponding overlapping panel pixels 101 to control the brightness of the overlapping panel pixels 101.

In this embodiment, only the first-type image data to be adjusted may need to be selected from a portion of the initial image data sets D0 and the coordinates of this first-type image data to be adjusted may need to be adjusted to obtain the overlapping image data. The coordinates of the image data in the reference image data sets may not need to be adjusted, thus minimizing the computational burden on the signal processor.

For example, as shown in FIG. 2 and FIG. 6, when the projection frame feature may include the projection pixel information shown in FIG. 2, the initial image data D0 in FIG. 6 may be divided into a red initial image data set DOR, a green initial image data set DOG, and a blue initial image data set DOB. The red initial image data set DOR may be used as the reference image data set, while the green initial image data set DOG and the blue initial image data set DOB may both be used as the image data sets to be adjusted. Assuming that the first to eighth columns of the image data in the red initial image data set DOR correspond to the first to eighth columns of panel pixels in the red display panel 10R and the first to eighth columns of projection pixels in the red projection frame 20R, respectively, since the second to eighth columns of projection pixels in the red projection frame 20R are overlapping projection pixels 201, the second to eighth columns of image data in the red initial image data set DOR may be the overlapping image data. Assuming that the pixels in the first to the eighth columns of the to-be-displayed image IM correspond to the image data in the first to the eighth columns of the initial image data set D0, the overlapping image data in the reference image data sets may correspond to the image data in the second to the eighth columns of the to-be-displayed image IM. Therefore, the image data in the second to the eighth columns of the green initial image data set DOG and the blue initial image data set DOB may be used as the first-type image data to be adjusted. Since the projection pixels in the first to the seventh columns of the green projection frame 20G and the blue projection frame 20B may be overlapping projection pixels 201, the coordinates of the first-type image data to be adjusted (the second to the eighth columns of the image data) in the green initial image data set DOG and the blue initial image data set DOB may be adjusted to the first column to the seven column, respectively. The overlapping image data derived from the first-type image data to be adjusted may also correspond to the image data in the second to the eighth columns of the to-be-displayed image IM and may be displayed by the overlapping projection pixels 201 in the green projection frame 20G and the blue projection frame 20B. At this time, the overlapping projection pixels in the red projection frame 20R, the green projection frame 20G and the blue projection frame 20B on the target projection surface 20 may be used to display the screens corresponding to the second to the eighth pixel columns of the image IM to be displayed, and a clear projection frame 200 may be presented on the target projection surface 20.

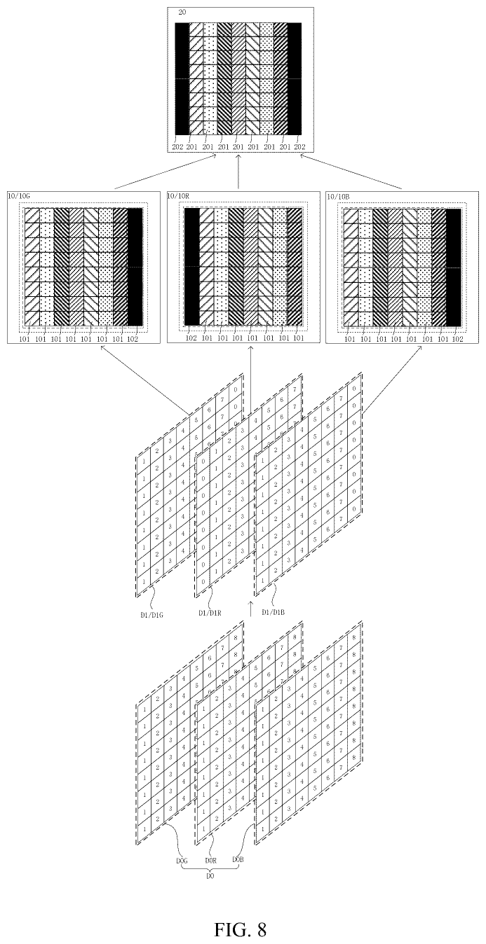

FIG. 8 is a schematic diagram illustrating the relationship between initial image data and display screens on display panels, according to an embodiment of the present disclosure.

For example, as shown in FIG. 2 and FIG. 8, when the projection frame features include the projection pixel information shown in FIG. 2, the initial image data D0 may be divided into a red initial image data set DOR, a green initial image data set DOG, and a blue initial image data set DOB. The green initial image data set DOG and the blue initial image data set DOB may both be used as reference image data sets, while the red initial image data set DOR may be used as the image data set to be adjusted. The first to eighth columns of image data in the green initial image data D0 set and the blue initial image data set DOB may correspond to the first to eighth columns of panel pixels in the green display panel 10G and the blue display panel 10B, respectively, and correspond to the first to eighth columns of projection pixels in the green projection frame 20G and the blue projection frame 20B, respectively. Since the first to seventh columns of projection pixels in the green projection frame 20G and the blue projection frame 20B are overlapping projection pixels 201, the 1st to 7th columns of image data in the green initial image data set DOG may be overlapping image data and the 1st to 7th columns of image data in the blue initial image data set DOB may be overlapping image data. Assuming that the pixels in the first to eighth columns of the to-be-displayed image IM correspond to the image data in the first to eighth columns of the initial image data set D0, respectively, the overlapping image data in the reference image data sets may corresponds to the image data in the first to seventh columns of the to-be-displayed image IM. Therefore, the first to seventh columns of the image data in the red initial image data set DOR may be used as the first-type image data to be adjusted. Since the second to eighth columns of the projection pixels in the red projection frame 20R are overlapping projection pixels 201, the coordinates of the first-type image data to be adjusted (the first to seventh columns of the image data) in the red initial image data set DOR may be changed to the second to eighth columns. The overlapping image data derived from the first-type image data to be adjusted may also correspond to the image data in the first to seventh columns of the to-be-displayed image IM and may be displayed by the overlapping projection pixels 201 in the red projection frame 20R. At this point, the overlapping projection pixels in the red, green, and blue projection frames 20R, 20G, and 20B on the target projection surface 20 may be used to display the images corresponding to the pixels in the first to seventh columns of the to-be-displayed image IM. A clear projection frame 200 may be presented on the target projection surface 20.

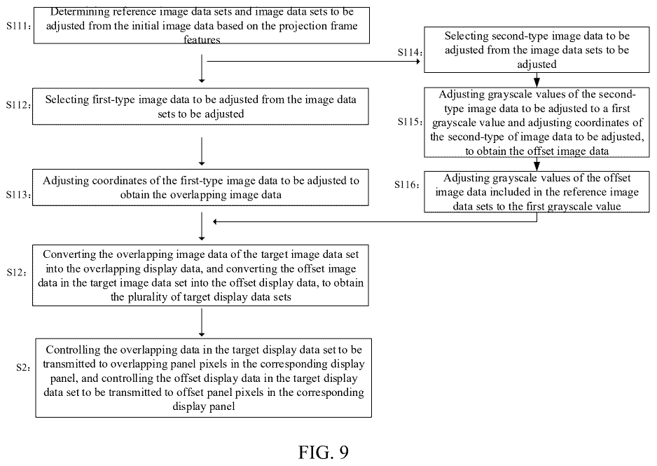

FIG. 9 is a flow chart of a frame alignment method of a display module provided in another embodiment of the present disclosure.

In the embodiment shown in FIG. 9, based on projection frame features, reconstructing the initial image data D0 of the to-be-displayed image IM to obtain the target image data sets D1 may also include S114 to S116.

S114: selecting a second-type image data to be adjusted from the image data sets to be adjusted.

The second-type image data to be adjusted may be the image data in the image data sets to be adjusted other than the first-type image data to be adjusted. For example, as shown in FIG. 6, the green initial image data set DOG and the blue initial image data set DOB may be the image data sets to be adjusted. The image data in the second to the eighth columns of the green initial image data set DOG and the blue initial image data set DOB may be the first-type image data to be adjusted. Therefore, the image data in the first column of the green initial image data set DOG and the blue initial image data set DOB may be second-type image data to be adjusted. For example, as shown in FIG. 8, the red initial image data set DOR may be the image data set to be adjusted. The image data in the second to eighth columns of the red initial image data set DOR may be the first-type image data to be adjusted. Therefore, the image data in the first column of the red initial image data set DOR may be the second-type image data to be adjusted.

S115: adjusting the grayscale values of the second-type image data to be adjusted to the first grayscale value and adjusting the coordinates of the second-type image data to be adjusted to obtain the offset image data.

S116: adjusting the grayscale values of the offset image data included in the reference image data sets to the first grayscale value.

The coordinates of the second-type image data to be adjusted may be adjusted to obtain the offset image data. After the adjustment, the coordinates of the second-type image data to be adjusted may correspond to the coordinates of the offset panel pixels 102 in the display panels 10, such that the offset image data obtained from the second-type image data to be adjusted may be converted into the offset display data and the offset display data may be transmitted to the corresponding offset panel pixels 102 to control the luminance of the offset panel pixels 102. In addition, the grayscale value of the offset image data in the parameter image data sets may be adjusted to the first grayscale value, such that all the offset panel pixels 102 in the display panels 10 may display the first grayscale value, and all the offset projection pixels 202 on the target projection surface 20 may display the first grayscale value.

For example, as shown in FIG. 6, when the second to eighth columns of image data in the green initial image data set DOG and the blue initial image data set DOB are all first-type image data, and the first column of image data in the green initial image data set DOG and the first column of image data in the blue initial image data set DOB are second-type image data, the grayscale values of the first column of image data may be all changed to the first grayscale value. Furthermore, since the eighth column of projection pixels in the green projection frame 20G and the blue projection frame 20B are offset projection pixels 202, the coordinates of the second-type image data to be adjusted (the first column of image data) in the green initial image data set DOG and the blue initial image data set DOB may be changed to the eighth column. The offset image data obtained from the second-type image data to be adjusted may be displayed by the offset projection pixels 202 in the green projection frame 20G and the blue projection frame 20B that do not overlap with the red projection frame 20R.

For another example, as shown in FIG. 8, when the image data in the first column to the seventh column of the red initial image data set DOR are all first-type image data and the image data in the eighth column of the red initial image data set DOR is second-type image data, the grayscale values of the image data in the eighth column may be all changed to the first grayscale value. Further, since the projection pixels in the first column of the red projection frame 20R may be offset projection pixels 202, the coordinates of the second-type image data to be adjusted (the eighth column) in the red initial image data set DOR may be changed to the first column. The offset image data derived from the second-type image data to be adjusted may be displayed by the offset projection pixels 202 in the red projection frame 20R that do not overlap with the green projection frame 20G or the blue projection frame 20B.

The first grayscale value may be grayscale 0. Correspondingly, the offset panel pixels 102 in each display panel 10 may all receive display data corresponding to grayscale 0. Therefore, the offset panel pixels 102 in the display panels 10 may display black, and correspondingly, the offset projection pixels 202 in each projection frame 200 may display black.

In another embodiment, the first grayscale value may also be grayscale 255. In yet some other embodiments, the first grayscale value may also be other grayscales. For example, the first grayscale value of one offset panel pixel 102 may be the same as the grayscale value of its adjacent overlapping panel pixel 101.

In one embodiment, only the coordinates of the second-type image data to be adjusted may be altered to obtain the offset image data, without processing the grayscale values of the second-type image data to be adjusted or the grayscale values of the offset image data included in the reference image data sets.

In some embodiments of the present disclosure, the display module 01 may include a first color display panel 10, a second color display panel 10, and a third color display panel 10. The image displayed by the first color display panel 10 may be projected onto the target projection surface 20 as a first color projection frame 20G, the image displayed by the second color display panel 10 may be projected onto the target projection surface 20 as a second color projection frame 200, and the image displayed by the third color display panel 10 may be projected onto the target projection surface 20 as a third color projection frame 200. For example, among the first color display panel 10, the second color display panel 10, and the third color display panel 10, one may be a red display panel 10R, another one may be a green display panel 10G, and another one may be a blue display panel 10B. Correspondingly, among the first color projection frame 20G, the second color projection frame 200, and the third color projection frame 200, one may be a red projection frame 20R, another one may be a green projection frame 20G, and another one may be a blue projection frame 20B. The following description uses as an example one embodiment where the first color display panel 10 may be a green display panel 10G, the second color display panel 10 may be a red display panel 10R, and the third color display panel 10 may be a blue display panel 10B.

In one embodiment, in a first direction parallel to the target projection surface 20, the second color projection frame 20R may be offset by n projection pixels relative to both the first color projection frame 20G and the third color projection frame 20B. That is, the second color projection frame 20R may be offset by n projection pixels relative to both the first color projection frame 20G and the third color projection frame 20B, along a first projection direction. For example, as shown in FIG. 2, the first direction may be the row direction and the first offset direction may be to the left, and n may be 1. That is, the red projection frame 20R may be offset by one column of projection pixels to the left relative to the blue and green projection frames 20B and 20G.

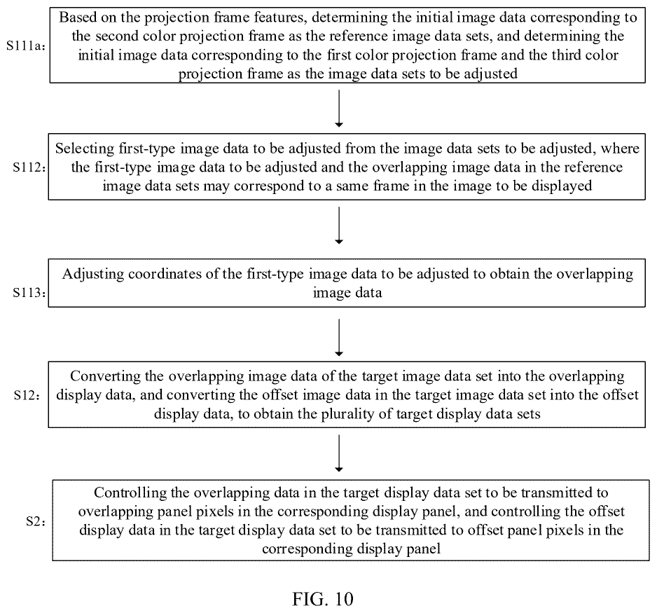

FIG. 10 is a flow chart illustrating a frame alignment method of a display module provided in an embodiment of the present disclosure. In the embodiment shown in FIG. 10, based on the projection frame features, determining the reference image data sets and the target image data sets from the plurality of initial image data D0 in S111 may include:

S111a: based on the projection frame features, determining the initial image data D0 corresponding to the second color projection frame 20R as the reference image data sets, and determining the initial image data D0 corresponding to the first color projection frame 20G and the third color projection frame 20B as the target image data sets.

The plurality of image data in the initial image data D0 corresponding to the second color display panel 10R may be used as the reference image data sets, and the plurality of image data in the initial image data D0 corresponding to the first color display panel 10G and the third color display panel 10B may be used as the target image data sets.

In this embodiment, based on the projection frame features, the different and completely overlapping projection frames 200 may be determined, and the initial image data D0 corresponding to each of these projection frames 200 may be identified as the image data sets to be adjusted.

For example, as shown in FIG. 8, the red projection frame 20R may be offset to the left by one column of projection pixels relative to the blue projection frame 20B and the green projection frame 20G. The initial image data D0 corresponding to the red projection frame 20R may be identified as the reference image data sets, while the initial image data D0 corresponding to the green projection frame 20G and the initial image data D0 corresponding to the blue projection frame 20B may be identified as the image data sets to be adjusted.

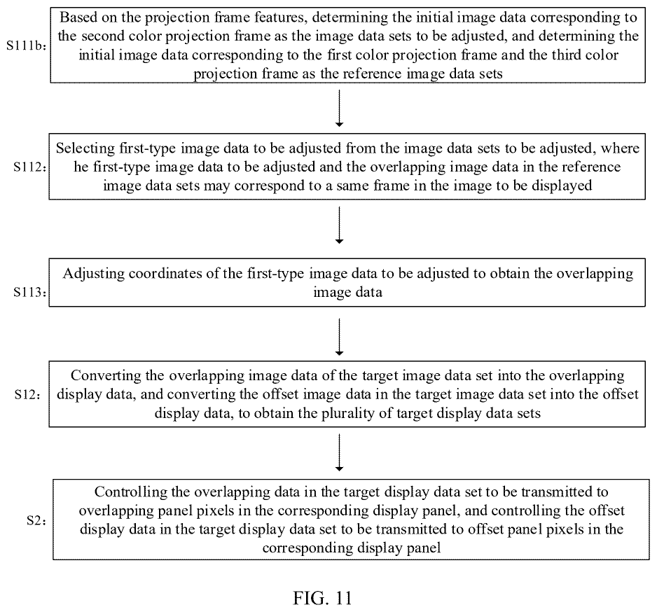

FIG. 11 is a flow chart of a frame alignment method of a display module provided in an embodiment of the present disclosure. In the embodiment shown in FIG. 11, based on projection frame features, determining the reference image data sets and the target image data sets from the multiple initial image data D0 in S111 may include:

S111b: based on the projection frame features, determining the initial image data D0 corresponding to the second color projection frame 20R as the target image data sets, and determining the initial image data D0 corresponding to the first color projection frame 20G and the third color projection frame 20B as the reference image data sets. That is, the multiple image data corresponding to the second color display panel 10R in the initial image data D0 may be used as the target image data sets, and the multiple image data corresponding to the first color display panel 10G and the third color display panel 10B in the initial image data D0 may be used as the reference image data sets.

In this embodiment, based on the projection frame features, the different and completely overlapping projection frames 200 can be determined. The initial image data D0 corresponding to each of these projection frames 200 may then be determined as the reference image data sets, thereby reducing the workload of obtaining multiple target image data sets D1.

For example, as shown in FIG. 7, the red projection frame 20R may be offset to the left by one column of projection pixels relative to the blue and green projection frames 20B and 20G. The initial image data sets D0 corresponding to the green and blue projection frames 20G and 20B may be determined as the reference image data sets, while the initial image data sets D0 corresponding to the red projection frame 20R may be determined as the image data sets to be adjusted.

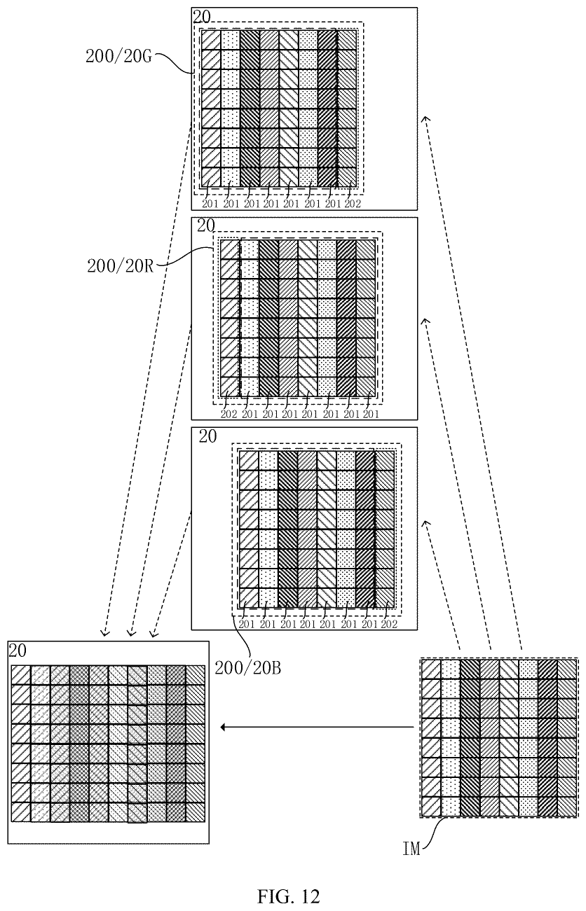

FIG. 12 is a schematic diagram of a projection frame of an image to be displayed on a target projection surface, according to an embodiment of the present disclosure.

In one embodiment, in a first direction parallel to the target projection surface 20, the second color projection frame 20R may be offset by n projection pixels relative to the first color projection frame 20G, and the third color projection frame 20B may be offset by m projection pixels relative to the second color projection frame 20R. That is, the first color projection frame 20G and the third color projection frame 20B may be offset in the first direction to different sides of the second color projection frame 20R. Here, n and m may be equal or unequal.

For example, as shown in FIG. 12, the first direction may be the row direction, the first offset direction may be leftward, and the second offset direction may be rightward. The green projection frame 20G may be offset to the left by one column of projection pixels relative to red projection frame 20R, and blue projection frame 20B may be offset to the right by one column of projection pixels relative to red projection frame 20R. Assume that the pixels in the first column to the eighth column of the image IM to be displayed correspond to the image data in the first column to the eighth column of the initial image data sets D0, respectively, these columns may correspond to the panel pixels in the first column to the eighth column of the display panels 10, respectively. The projection pixels from the second to the seventh columns in the red projection frame 20R may be overlapping projection pixels 201, and correspondingly, the panel pixels from the second to the seventh columns in the red display panel 10R may be overlapping panel pixels 101, and the image data from the second to the seventh columns in the red initial image data set DOR may be overlapping image data; the projection pixels from the first column to the eighth column in the red projection frame 20R may be offset projection pixels 202, and correspondingly, the panel pixels from the first column to the eighth column in the red display panel 10R may be offset panel pixels 102, and the image data from the first column to the eighth column in the red initial image data set DOR may be offset image data. The third to the eighth columns of projection pixels in the green projection frame 20G may be overlapping projection pixels 201, and correspondingly, the third to the eighth columns of panel pixels in the green display panel 10G may be overlapping panel pixels 101, and the third to the eighth columns of image data in the green initial image data set DOG may be overlapping image data. The first and second columns of projection pixels in the green projection frame 20G may be offset projection pixels 202, and correspondingly, the first and second columns of panel pixels in the green display panel 10G may be offset panel pixels 102, and the first and second columns of image data in the green initial image data set DOG may be offset image data. The first through sixth columns of projection pixels in the blue projection frame 20B may be overlapping projection pixels 201. Correspondingly, the first through sixth columns of panel pixels in the blue display panel 10B may be overlapping panel pixels 101, and the first through sixth columns of image data in the blue initial image data set DOB may be overlapping image data. The seventh and eighth columns of projection pixels in the blue projection frame 20B may be offset projection pixels 202. Correspondingly, the seventh and eighth columns of panel pixels in the blue display panel 10B may be offset panel pixels 102, and the seventh and eighth columns of image data in the blue initial image data set DOB may be offset image data.

The initial image data D0 may be divided into a green initial image data set DOG, a green initial image data set DOG, and a blue initial image data set DOB. The red initial image data set DOR may be used as the reference image data set, and both the green initial image data set DOG and the blue initial image data set DOB may be used as the image data sets to be adjusted.

In one embodiment, as shown in FIG. 10, based on the projection frame features, determining the reference image data sets and the target image data sets from the plurality of initial image data D0 in S111 may include:

S111a: based on the projection frame features, determining the initial image data D0 corresponding to the second color projection frame 20R as the reference image data sets, and determining the initial image data D0 corresponding to the first color projection frame 20G and the third color projection frame 20B as the target image data sets. That is, the plurality of image data in the initial image data D0 corresponding to the second color display panel 10R may be used as the reference image data sets, and the plurality of image data in the initial image data D0 corresponding to the first color display panel 10G and the third color display panel 10B may be used as the target image data sets.

In this embodiment, based on the projection frame features, a projection frame 200 located near the center may be identified among the multiple projection frames 200. The projection pixels of this projection frame 200 may overlap with the projection pixels of other projection frames 200, and the initial image data D0 corresponding to each of these projection frames 200 may be determined as the reference image data sets.

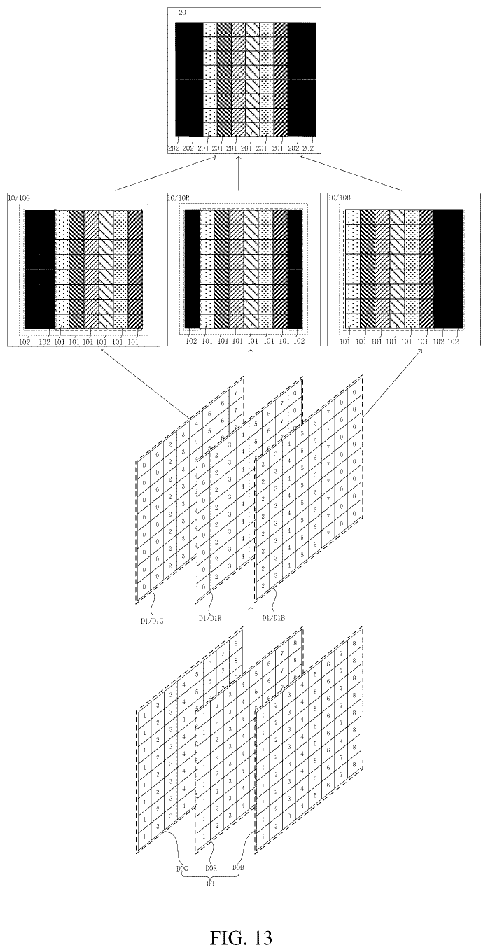

FIG. 13 illustrates a schematic diagram of the relationship between initial image data and the display images of display panels in accordance with an embodiment of the present disclosure.

For example, as shown in FIGS. 12 and 13, when the projection frame features include the projection pixel information shown in FIG. 12, the initial image data set D0 corresponding to the red projection frame 20R may be determined as the reference image data sets, while the initial image data set D0 corresponding to the green projection frame 20G and the initial image data set D0 corresponding to the blue projection frame 20B may be determined as the image data sets to be adjusted. Since the second through seventh columns of projection pixels in the red projection frame 20R may be overlapping projection pixels 201, the second through seventh columns of image data in the red initial image data set DOR may be overlapping image data. That is, the overlapping image data in the reference image data sets may correspond to the second through seventh columns of pixels in the to-be-displayed image IM. Therefore, as shown in FIG. 13, the second through seventh columns of image data in the green initial image data set DOG and the blue initial image data set DOB may be used as the first-type image data to be adjusted. Since the projection pixels in the 3rd to 8th columns in the green projection frame 20G may be overlapping projection pixels 201 and the projection pixels in the 1st to 6th columns in the blue projection frame 20B may be overlapping projection pixels 201, the coordinates of the first-type image data to be adjusted (the 2nd to 7th columns of image data) in the green initial image data set DOG may be changed to the 3rd to 8th columns, and the coordinates of the first-type image data to be adjusted (the 2nd to 7th columns of image data) in the blue initial image data set DOB may be changed to the 1st to 6th columns. The overlapping image data derived from the first-type image data to be adjusted in the green initial image data set DOG and the overlapping image data derived from the first-type image data to be adjusted in the blue initial image data set DOB may both correspond to the image of the second through seventh columns of pixels in the to-be-displayed image IM, and may be displayed by overlapping projection pixels 201 in the green projection frame 20G and the blue projection frame 20B. At this point, the overlapping projection pixels in the red projection frame 20R, the green projection frame 20G, and the blue projection frame 20B on the target projection surface 20 may be used to display the image corresponding to the second through seventh columns of pixels in the to-be-displayed image IM, resulting in a clear projection frame 200 on the target projection surface 20.

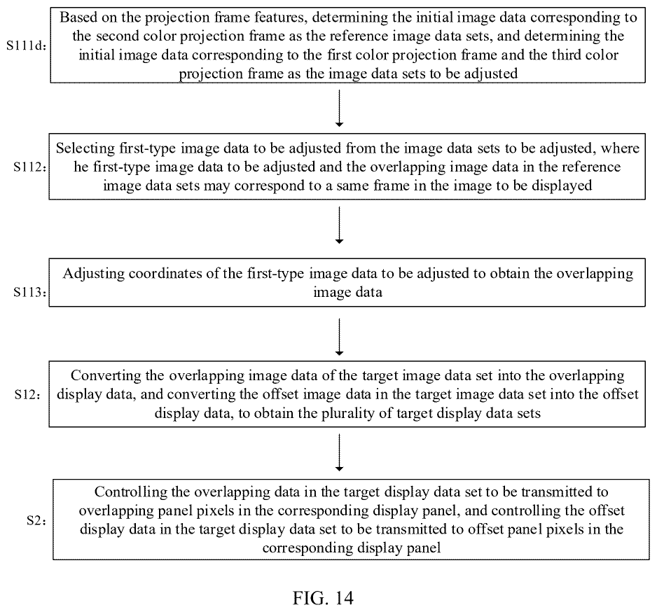

FIG. 14 is a flow chart of a frame alignment method of a display module provided in another embodiment of the present disclosure. In the embodiment shown in FIG. 14, based on projection frame features, determining the reference image data sets and the target image data sets from the multiple initial image data D0 in S111 may include:

S111d: based on the projection frame features, determining the initial image data D0 corresponding to the first color projection frame 20G as the reference image data sets, and determining the initial image data D0 corresponding to the second color projection frame 20R and the third color projection frame 20B as the target image data sets. That is, the multiple image data in the initial image data D0 corresponding to the first color display panel 10G may be used as the reference image data sets, and the multiple image data in the initial image data D0 corresponding to the second color display panel 10R and the third color display panel 10B may be used as the target image data sets.

In this embodiment, based on the projection frame features, a projection frame 200 that may be off to one side may be determined from the multiple projection frames 200, and the initial image data D0 corresponding to each of these projection frames 200 may be determined as the reference image data sets.

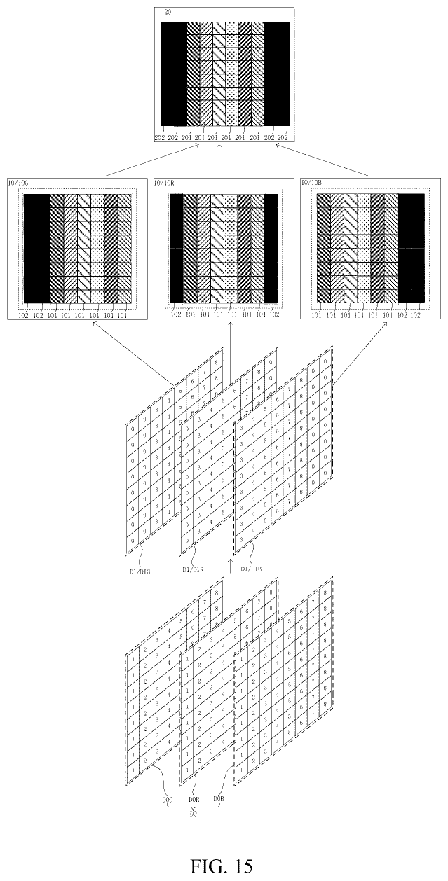

FIG. 15 is a schematic diagram illustrating the relationship between initial image data and the display screens of display panels, according to an embodiment of the present disclosure.

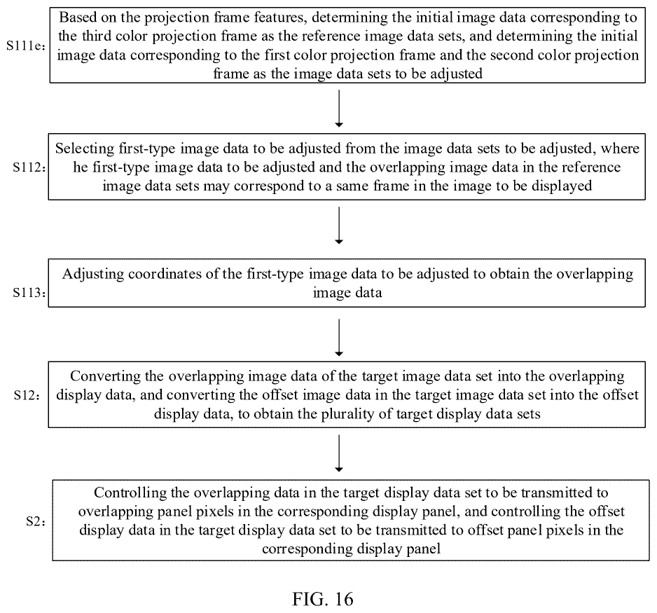

For example, as shown in FIG. 12 and FIG. 15, when the projection frame features include the projection pixel information shown in FIG. 12, the initial image data set D0 corresponding to the green projection frame 20G may be determined as the reference image data sets, while the initial image data set D0 corresponding to the red projection frame 20R and the initial image data set D0 corresponding to the blue projection frame 20B may be determined as the image data sets to be adjusted. Since the third through eighth columns of projection pixels in the green projection frame 20G may be overlapping projection pixels 201, the third through eighth columns of image data in the green initial image data set DOG may be overlapping image data. In other words, the overlapping image data in the reference image data sets may correspond to the third through eighth columns of pixels in the to-be-displayed image IM. Therefore, as shown in FIG. 16, the third through eighth columns of image data in the red initial image data set DOR and the blue initial image data set DOB may be designated as the first-type image data to be adjusted. Since the 2nd to 7th columns of projection pixels in the red projection frame 20R may be overlapping projection pixels 201 and the 1st to 6th columns of projection pixels in the blue projection pixels may be overlapping projection pixels 201, the coordinates of the first-type image data to be adjusted (the 3rd to 8th columns of image data) in the red initial image data set DOR may be changed to the 2nd to 7th columns, and the coordinates of the first-type image data to be adjusted (the 3rd to 8th columns of image data) in the blue initial image data set DOB may be changed to the 1st to 6th columns. The overlapping image data obtained from the first-type image data to be adjusted in the red initial image data set DOR and the overlapping image data obtained from the first-type image data to be adjusted in the blue initial image data set DOB may both correspond to the images of the 3rd to 8th columns of pixels in the to-be-displayed image IM, and may be displayed by the overlapping projection pixels 201 in the red projection frame 20R and the blue projection frame 20B. At this time, the overlapping projection pixels in the red projection frame 20R, the green projection frame 20G and the blue projection frame 20B on the target projection surface 20 may be used to display the images corresponding to the 3rd to 8th columns of pixels of the to-be-displayed image IM, and a clear projection frame 200 may be presented on the target projection surface 20.

FIG. 16 is a flow chart of a frame alignment method of a display module provided in another embodiment of the present disclosure. In the embodiment shown in FIG. 16, based on projection frame features, determining the reference image data sets and the target image data sets from the multiple initial image data D0 in S111 may include:

S111e: based on the projection frame features, determining the initial image data D0 corresponding to the third color projection frame 20B as the reference image data sets, and determining the initial image data D0 corresponding to the second color projection frame 20R and the first color projection frame 20G as the target image data sets. That is, the multiple image data in the initial image data D0 corresponding to the third color display panel 10B may be used as the reference image data sets, and the multiple image data in the initial image data D0 corresponding to the second color display panel 10R and the first color display panel 10G may be used as the target image data sets.

In this embodiment, based on the projection frame features, a projection frame 200 that may be off to one side may be determined from the multiple projection frames 200, and the initial image data D0 corresponding to each of these projection frames 200 may be determined as the reference image data sets.

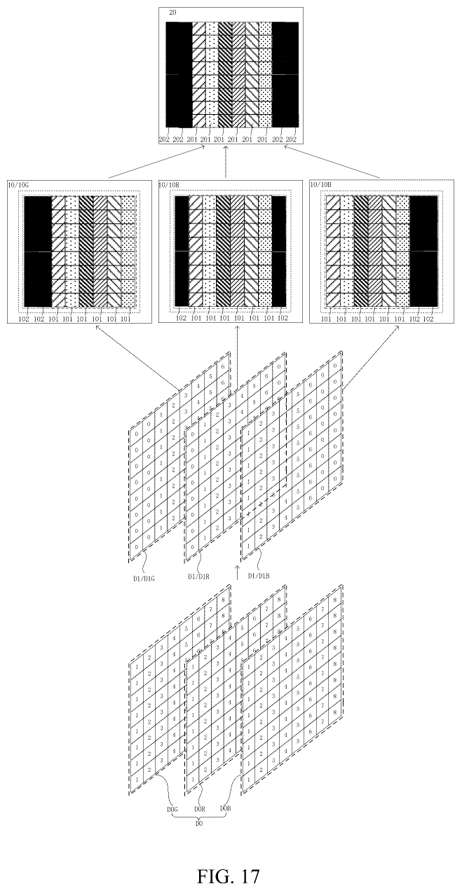

FIG. 17 is a schematic diagram illustrating the relationship between initial image data and the display screens of display panels, according to an embodiment of the present disclosure.

For example, as shown in FIG. 12 and FIG. 17, when the projection frame features include the projection pixel information shown in FIG. 12, the initial image data set D0 corresponding to the blue projection frame 20B may be determined as the reference image data sets, while the initial image data set D0 corresponding to the red projection frame 20R and the initial image data set D0 corresponding to the green projection frame 20G may be determined as the image data sets to be adjusted. Since the third through eighth columns of projection pixels in the blue projection frame 20B may be overlapping projection pixels 201, the third through eighth columns of image data in the blue projection frame 20B may be overlapping image data. In other words, the overlapping image data in the reference image data sets may correspond to the third through eighth columns of pixels in the to-be-displayed image IM. Therefore, as shown in FIG. 16, the third through eighth columns of image data in the red initial image data set DOR and the green initial image data set DOG may be designated as the first-type image data to be adjusted. Since the 2nd to 7th columns of projection pixels in the red projection frame 20R may be overlapping projection pixels 201 and the 3rd to 8th columns of projection pixels in the green projection pixels may be overlapping projection pixels 201, the coordinates of the first-type image data to be adjusted (the 3rd to 8th columns of image data) in the red initial image data set DOR may be changed to the 2nd to 7th columns, and the coordinates of the first-type image data to be adjusted (the 1st to 6th columns of image data) in the green initial image data set DOG may be changed to the 3rd to 8th columns. The overlapping image data obtained from the first-type image data to be adjusted in the red initial image data set DOR and the overlapping image data obtained from the first-type image data to be adjusted in the green initial image data set DOG may both correspond to the images of the 3rd to 8th columns of pixels in the to-be-displayed image IM, and may be displayed by the overlapping projection pixels 201 in the red projection frame 20R and the green projection frame 20G. At this time, the overlapping projection pixels in the red projection frame 20R, the green projection frame 20G and the blue projection frame 20B on the target projection surface 20 may be used to display the images corresponding to the 3rd to 8th columns of pixels of the to-be-displayed image IM, and a clear projection frame 200 may be presented on the target projection surface 20.

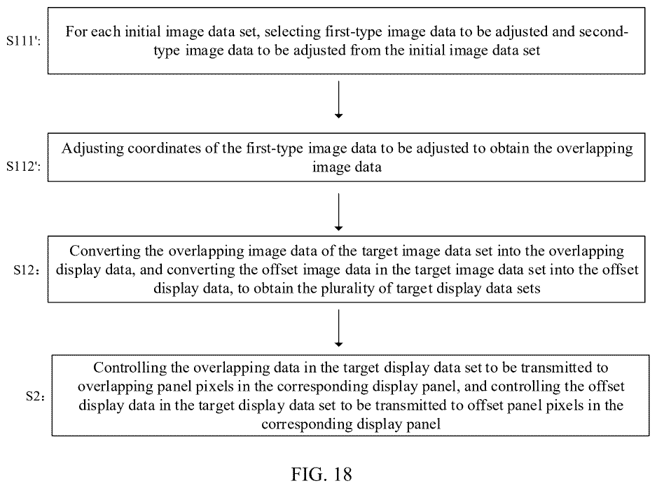

FIG. 18 is a flow chart of a frame alignment method of a display module provided in another embodiment of the present disclosure.

In the embodiment shown in FIG. 18, based on the projected screen features, reconstructing the initial image data D0 of the to-be-displayed image IM to obtain the target image data sets D1 in S11 may include S111′ and S112′.

S111′: for each initial image data set, selecting first-type image data to be adjusted and second-type image data to be adjusted from the initial image data set D0.

The initial image data D0 may include multiple initial image data sets, where the images corresponding to the image data in different initial image data sets may be displayed on different display panels 10. The first-type image data included in each of the different initial image data sets may correspond to one same image in the to-be-displayed image IM, and the second-type image data may include the image data in the initial image data set other than the first-type image data. The second-type image data in one same initial image data set may be located on two sides of the first-type image data.

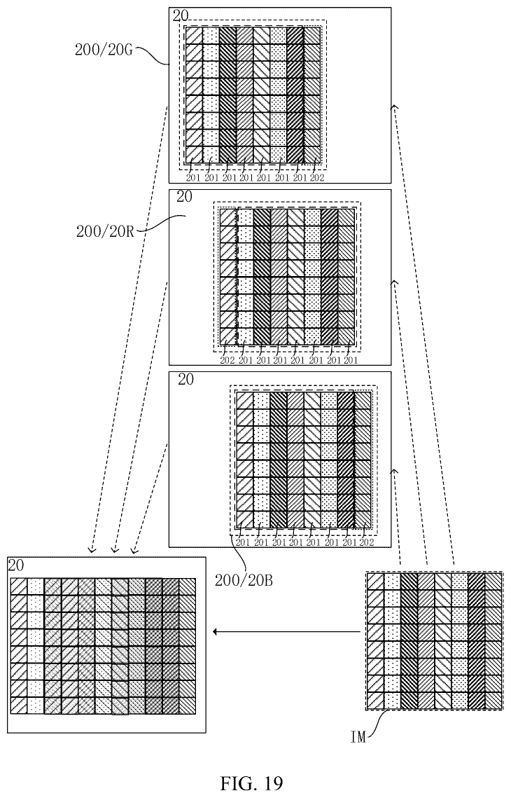

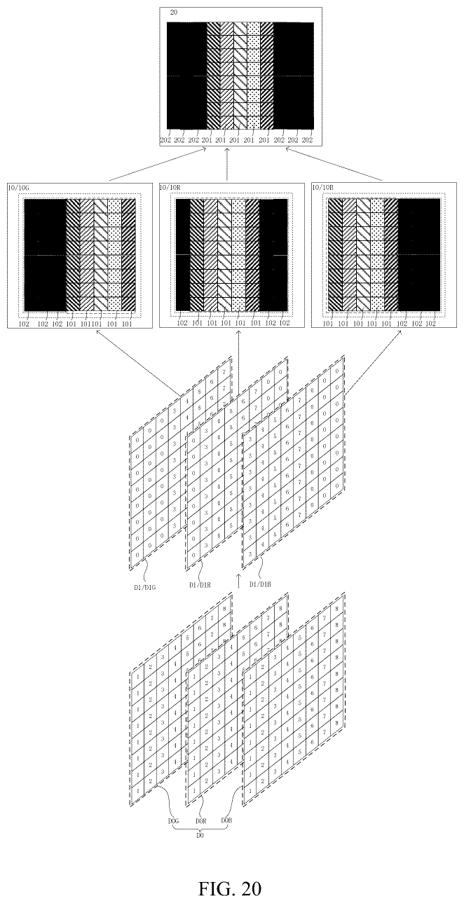

FIG. 19 is a schematic diagram of a projection frame of an image to be displayed on a target projection surface, according to an embodiment of the present disclosure. FIG. 20 is a schematic diagram of the relationship between initial image data and display screens of display panels, according to an embodiment of the present disclosure.

For example, as shown in FIG. 20, the initial image data D0 may be divided into a green initial image data set DOG, a red initial image data set DOR, and a blue initial image data set DOB. The green projection frame 20G may be offset to the left by two columns of projection pixels relative to the red projection frame 20R, and the blue projection frame 20B may be offset to the right by one column of projection pixels relative to the red projection frame 20R. Therefore, each projection frame 200 may include five columns of projection overlapping pixels 201, and each display panel 10 may include five columns of overlapping panel pixels 101. Therefore, the initial image data set may include five columns of overlapping image data, which may serve as the first-type image data to be adjusted. As shown in FIG. 20, the third to seventh columns of the eight columns of initial image data included in each initial image data group, representing the same image, may be selected as the first-type image data to be adjusted. Further, the first, second, and eighth columns of the eight columns of initial image data included in each initial image data set may be the second-type image data to be adjusted and may be located on either side of the first-type image data to be adjusted.

It should be noted that the second-type image data to be adjusted being located on either side of the first-type image data to be adjusted means that the display image corresponding to the second-type image data to be adjusted may be located on either side of the display image corresponding to the first-type image data to be adjusted.

S112′: based on the projected image features, adjusting the coordinates of the first-type image data to be adjusted to obtain the overlapping image data.

When the first-type image data to be adjusted is located in the middle of the second-type image data to be adjusted, the display image corresponding to the first-type image data to be adjusted may be located away from the edge of the displayed image. By adjusting the first-type image data to be adjusted to the overlapping image data, when the image to be displayed is displayed on the target projection surface, the overlapping projection pixels 201 of each projection frame 200 may display the image away from the edge of the image to be displayed, avoiding the loss of large continuous areas of the image to be displayed and ensuring that the image to be displayed may be relatively complete when displayed on the target projection surface 20.

For example, as shown in FIG. 19 and FIG. 20, when the 4th to 8th columns of projection pixels in the green projection frame 20G are overlapping projection pixels 201, the 2nd to 6th columns of projection pixels in the red projection frame 20R are overlapping projection pixels 201, and the 1st to 5th columns of projection pixels in the blue projection frame 20B are overlapping projection pixels 201, the coordinates of the 3rd to 7th columns of image data in the green initial image data set DOG may be changed to the 4th to 8th columns to obtain green overlapping image data, the coordinates of the 3rd to 7th columns of image data in the red initial image data set DOR may be changed to the 2nd to 6th columns to obtain red overlapping image data, and the coordinates of the 3rd to 7th columns of image data in the blue initial image data set DOB may be changed to the 1st to 5th columns to obtain blue overlapping image data.

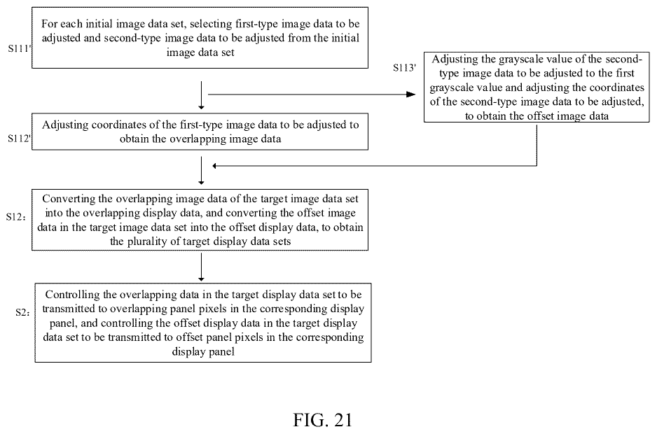

FIG. 21 is a flow chart of a frame alignment method of a display module provided in another embodiment of the present disclosure.

In the embodiment shown in FIG. 21, based on the projected screen features, reconstructing the initial image data D0 of the to-be-displayed image IM to obtain the target image data sets D1 in S11 may further include:

S113′: adjusting the grayscale values of the second-type image data to be adjusted to the first grayscale value and adjusting the coordinates of the second-type image data to be adjusted to obtain the offset image data.

For example, as shown in FIG. 19 and FIG. 20, the projection pixels in the first to third columns of the green projection frame 20G may be offset projection pixels 202, the projection pixels in the first and seventh to eighth columns of the red projection frame 20R may be offset projection pixels 202, and the projection pixels in the sixth to eighth columns of the blue projection frame 20B may be offset projection pixels 202. Therefore, the coordinates of the image data in the first, second, and eighth columns of the green initial image data set DOG may be changed to the first to third columns, and the grayscale values may be changed to grayscale 0, to obtain green offset image data. The coordinates of the image data in the first, second, and eighth columns of the red initial image data set DOR may be changed to the first column and the seventh to eighth columns, and the grayscale values may be changed to grayscale 0, to obtain red offset image data. The coordinates of the image data in the first, second, and eighth columns of the blue initial image data set DOB may be changed to the sixth to eighth columns, and the grayscale values may be changed to grayscale 0, to obtain blue offset image data.

In some other embodiment, the first grayscale value may also be 255. In yet some other embodiments, the first grayscale value may also be other grayscales. For example, the first grayscale value of one offset panel pixel 102 may be the same as the grayscale value of its adjacent overlapping panel pixel 101.

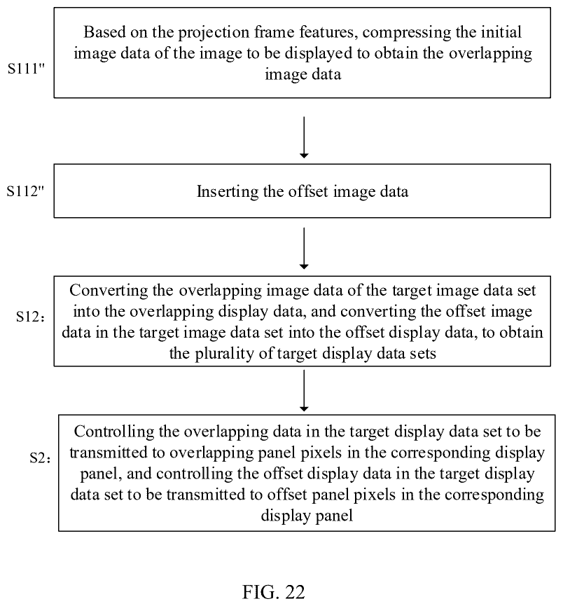

FIG. 22 is a flow chart of a frame alignment method of a display module provided in another embodiment of the present disclosure.

In the embodiment shown in FIG. 22, based on the projected screen features, reconstructing the initial image data D0 of the to-be-displayed image IM to obtain the target image data sets D1 in S11 may further include:

S111″: based on the projected image features, compressing the initial image data of the image to be displayed to obtain the overlapping image data.

The initial image data D0 may include multiple initial image data sets, where the images corresponding to the image data in different initial image data sets may be displayed on different display panels 10. The initial image data of the image to be displayed may be compressed to obtain the overlapping image data. This may be understood as compressing each initial image data set to obtain an overlapping image data set corresponding to each initial image data set. The data in different overlapping image data sets may correspond to overlapping panel pixels 101 in different display panels 10, and thus to overlapping projection pixels 201 in different projection frames.

In this embodiment, compressing the initial image data of the image to be displayed may be considered as reducing the resolution of the image to be displayed. Further, compressing the initial image data to obtain the overlapping image data may be considered as displaying the image to be displayed at a reduced resolution through overlapping panel pixels 101 in different display panels 10 and presenting it through overlapping projection pixels 201 in each projection frame. In this embodiment, although the resolution of displaying the image to be displayed on the display panels may be lower than the initial resolution of the image to be displayed, the display panel may still display a relatively complete image to be displayed, and a relatively complete image to be displayed may be presented on the target projection surface.

In some embodiments, reconstructing the initial image data D0 of the to-be-displayed image IM based on the projection frame features to obtain the target image data sets D1 in S11 may also include:

S112″: inserting the offset image data, such that the target image data sets include the overlapping image data and the offset image data.

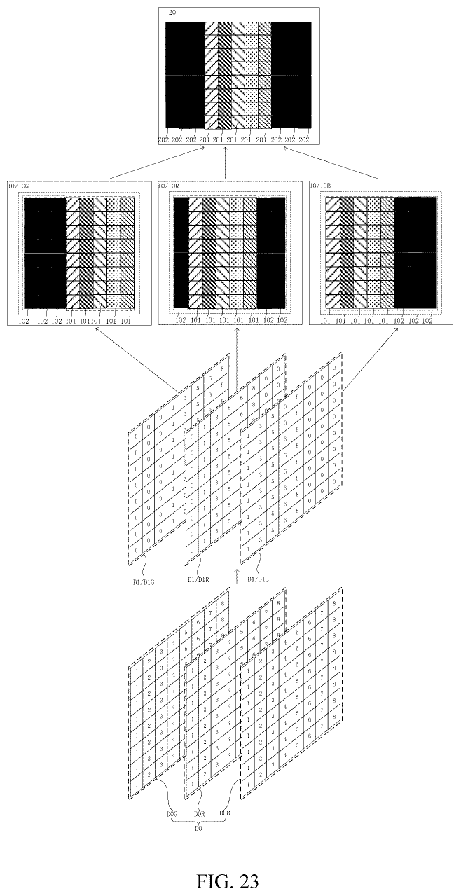

FIG. 23 is a schematic diagram illustrating a relationship between the initial image data and display images of display panels in accordance with an embodiment of the present disclosure.

For example, as shown in FIG. 23, the initial image data D0 may be divided into a green initial image data set DOG, a red initial image data set DOR, and a blue initial image data set DOB. As shown in FIG. 23, the green projection frame 20G may be offset to the left by two columns of projection pixels relative to the red projection frame 20R, and the blue projection frame 20B may be offset to the right by one column of projection pixels relative to the red projection frame 20R. Each projection frame 200 may include five columns of projection overlapping pixels 201, and each display panel 10 may include five columns of overlapping panel pixels 101. Therefore, the eight columns of image data in the initial image data sets may be compressed to obtain the five columns of overlapping image data in the target image data sets D1.

Compression of the initial image data may be performed by extracting pixel columns and/or pixel rows, as shown in FIG. 23. In some other embodiments, other methods of reducing image resolution may also be adopted and the present disclosure has no limit on this.

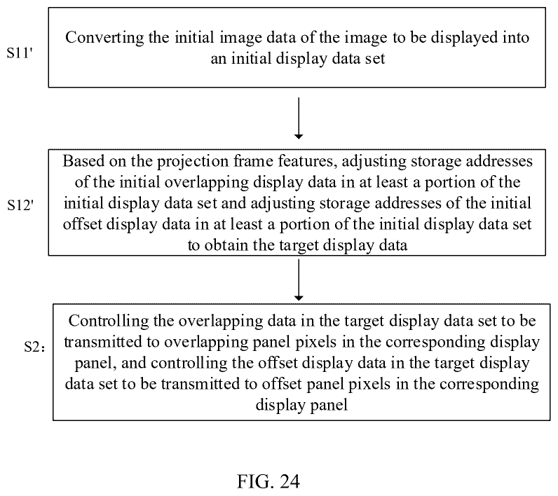

FIG. 24 is a flow chart of a frame alignment method of a display module provided in another embodiment of the present disclosure.

In the embodiment shown in FIG. 24, based on the projection frame features and initial image data D0 of the to-be-displayed image IM, obtaining the multiple target display data sets may include S11′ and S12′.

S11′: converting the initial image data D0 of the to-be-displayed image IM into the initial display data sets.

The initial display data sets may include initial overlapping display data and initial offset display data. The initial overlapping display data may be converted from the overlapping image data in the initial image data D0, and the initial offset display data may be converted from the offset image data in the initial image data D0. The overlapping image data in different initial image data D0 may correspond to the same frame in the to-be-displayed image IM.

S12′: based on the projected image features, adjusting the storage addresses of the initial overlapping display data in at least a portion of the initial display data sets, and adjusting the storage addresses of the initial offset display data in at least a portion of the initial display data sets, to obtain the target display data sets.

By adjusting the storage addresses of the initial overlapping display data in at least a portion of the initial display data sets, the initial overlapping display data may be transmitted to the overlapping panel pixels 101 in the display panels. By adjusting the storage addresses of the initial offset display data in at least a portion of the initial display data sets, the initial offset display data may be transmitted to the offset panel pixels 102 in the display panels.

In this embodiment, to ensure that overlapping panel pixels 101 in different display panels 10 display the same portion of the image IM to be displayed, the driver IC, after receiving image data and deriving display data based on the image data, may store the overlapping display data in correspondence with the overlapping panel pixels 101. In other words, in this embodiment, the core steps of the frame alignment method of the display module may be performed by the driver IC.

Assuming the projected image features shown in FIG. 4, the target display data sets corresponding to the red display panel will be used as an example for illustration.

In existing technologies, after obtaining the initial display data set corresponding to the red display panel based on the initial image data D0 of the image IM to be displayed, the initial display data in this initial display data set may be stored in a corresponding preset storage location. The initial display data corresponding to the first left column of the to-be-displayed image IM may be stored at a location, such that the initial display data is transmitted to the first left column of the display panel, causing the first left column of the to-be-displayed image IM to be displayed. The initial display data corresponding to the second left column of the to-be-displayed image IM may be stored at a location, such that the initial display data is transmitted to the second left column of the display panel, causing the second left column of the image to be displayed to be displayed, and so on.

In this embodiment, after the initial display data set corresponding to the red display panel is obtained based on the initial image data D0 of the to-be-displayed image IM, the initial display data in the initial display data set may be stored in the adjusted storage location. For example, the initial display data corresponding to the first left column of the to-be-displayed image IM may be stored in a location that allows such data to be transmitted to the second left column of the display panel to display the first left column of the to-be-displayed image IM. The initial display data corresponding to the third left column of the to-be-displayed image IM may be stored in a location that allows such data to be transmitted to the third left column of the display panel to display the second left column of the to-be-displayed image IM. Finally, as shown in FIG. 4, the panel pixels of the second column to the eighth column of the red display panel 10R may be used to display the first column to the eighth column of the to-be-displayed image IM.

It may be seen that the purpose of adjusting the storage address of the initial overlapping display data in the initial display data set may be to control the transmission of display data corresponding to the same frame in the to-be-displayed image IM to the overlapping panel pixels of the display panel. Therefore, adjusting the storage address of the initial overlapping display data in the initial display data set may have the same purpose as adjusting the coordinates of the first-type image data to be adjusted. Therefore, the selection of initial display data as the initial overlapping display data and how to adjust the storage address of the initial overlapping display data to correspond to the overlapping panel pixels 101 may be referenced to the concepts of selecting the first-type image data to be adjusted and adjusting the coordinates of the first-type image data to be adjusted, which will not be further elaborated here.

Further, the selection of initial display data as the initial offset display data and how to adjusting the storage address and data value of the initial offset display data to correspond to the offset panel pixels 201 may be referenced to the concepts of selecting the second-type image data to be adjusted and changing the coordinates and grayscale values of the second-type image data to be adjusted, which will not be further elaborated here.

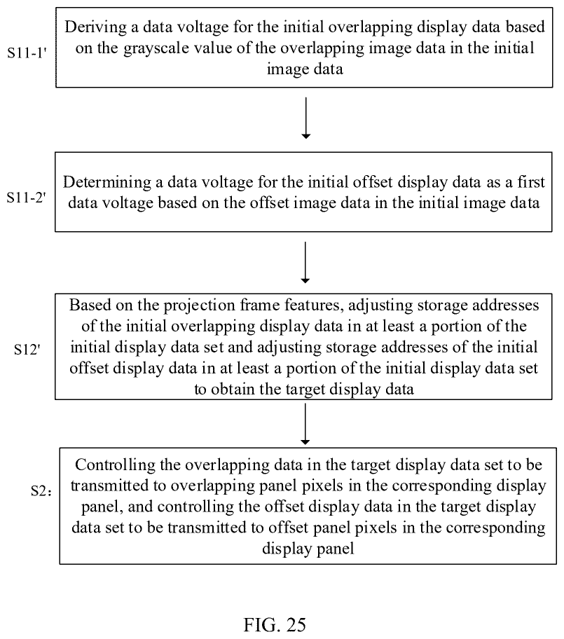

FIG. 25 is a flow chart of a frame alignment method of a display module provided by an embodiment of the present disclosure.

In the embodiment shown in FIG. 25, converting the initial image data D0 of the to-be-displayed image IM into the initial display data sets in S11′ may include:

S11-1′: obtaining a data voltage for the initial overlapping display data based on the grayscale values of the overlapping image data in the initial image data D0; and

S11-2′: determining the data voltage for the initial offset display data as the first data voltage based on the offset image data in the initial image data D0.

In this embodiment, the display data may specifically be data voltages. Correspondingly, the storage address of the initial overlapping display data in at least a portion of the initial display data sets, and the storage address of the initial offset display data in the at least a portion of the initial display data sets, may be adjusted. That is, the storage address of the data voltages may be adjusted.

In addition, the first data voltage may cause the offset panel pixels 101 to display black.

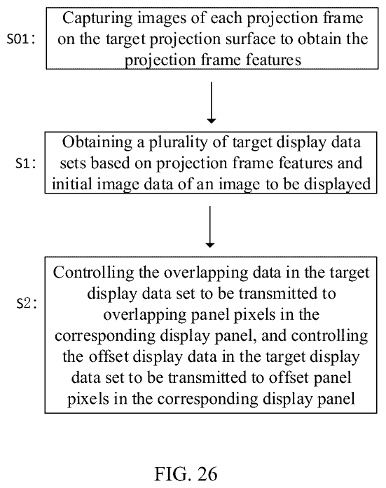

FIG. 26 is a flow chart of a frame alignment method of a display module provided by an embodiment of the present disclosure.

In the embodiment shown in FIG. 26, the frame alignment method of the display module may further include:

S01: capturing images of each projection frame 200 on the target projection surface 20 to obtain projection frame features.

S01 may be performed before S2. The screen alignment method provided in the embodiment of the present disclosure may be executed each time the display module 01 is powered on. Therefore, S01, S1, and S2 may be sequentially executed each time the display module 01 is powered on. The screen alignment method provided in the embodiment of the present disclosure may also be executed upon the initial startup of the display module 01 after leaving the factory. Therefore, S01, S1, and S2 may be sequentially executed upon the initial startup of the display module 01 after leaving the factory. The screen alignment method provided in the embodiment of the present disclosure may also be executed in response to user operation. When the user determines that screen alignment may be required through a key press or option, S01, S1, and S2 may be sequentially executed.

From the captured images of each projection frame 200 on the target projection surface 20, projection pixel information of overlap and misalignment between each projection frame 200 and other screens may be obtained.

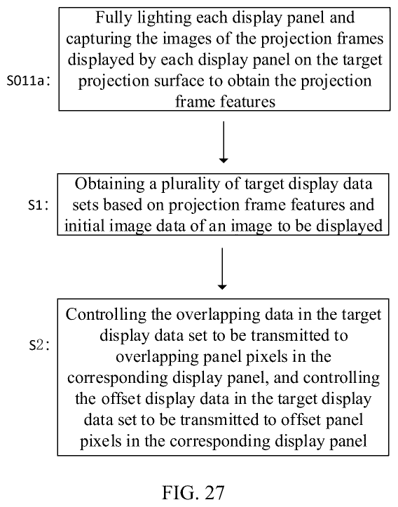

FIG. 27 is a flow chart of a frame alignment method of a display module provided by an embodiment of the present disclosure.

In the embodiment shown in FIG. 27, capturing the images of each projection frame 200 on the target projection surface 20 to obtain the projection frame features in S01 may include:

S011a: fully lighting each display panel 10 and capturing the images of the projection frames 200 of the images displayed by each display panel 10 on the target projection surface 20 to obtain the projection frame features.

After all display panels 10 in the display module 01 are fully illuminated, the images displayed by each display panel 10 may be displayed as the projection frames 200 on the target projection surface 20, and all overlapping and offset projection pixels between each projection frame 200 may be displayed. Therefore, images of each projection frame 200 on the target projection frame 200 may be obtained through a single image capture. In one embodiment, all display panels 10 may be fully illuminated simultaneously, such that all overlapping and offset projection pixels between each projection frame 200 may be displayed simultaneously.

By analyzing the images of each projection frame 200 captured after each display panel 10 is fully illuminated, the projection frame features may be obtained. For example, each pixel of the projection frames 200 may be segmented from the captured images, and information about overlapping and offset projection pixels of each projection frame 200 may be derived based on color variations within the image of the projection frame 200.

For example, as shown in FIG. 19, the green display panel 10G, the red display panel 10R, and the blue display panel 10B may be fully illuminated simultaneously. The green projection frame 20G, the red projection frame 20R, and the blue projection frame 20B may all appear simultaneously on the target projection surface 20. At this point, the first column of the captured projection pixel image may be green, the second column may be green, the third column may be yellow, the fourth through eighth columns may be white, the ninth column may be purple, the tenth column may be purple, and the eleventh column may be blue. Therefore, the fourth column of the green projection frame 20G may be inferred to be purple. The projection pixels from the first column to the eighth column in the red projection frame 20R may be overlapping projection pixels 201, the projection pixels from the second column to the sixth column in the blue projection frame 20B may be overlapping projection pixels 201, the projection pixels from the first to the third columns in the green projection frame 20G may be offset projection pixels 202, the projection pixels from the first column, the seventh column, and the eighth column in the red projection frame 20R may be offset projection pixels 202, and the projection pixels from the sixth to the eighth columns in the blue projection frame 20B may be offset projection pixels 202.

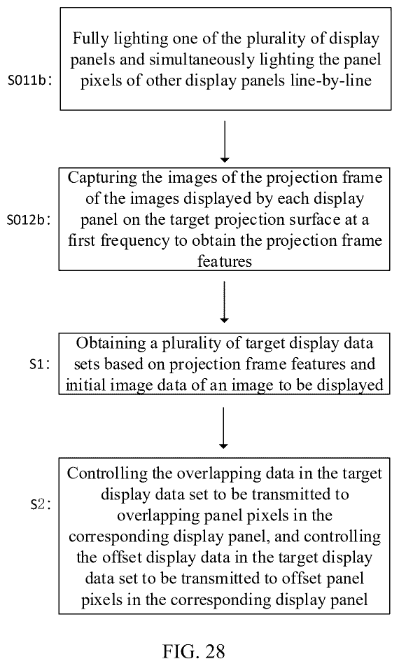

FIG. 28 is a flow chart of a frame alignment method of a display module provided by an embodiment of the present disclosure.

In the embodiment shown in FIG. 28, capturing the images of each projection frame 200 on the target projection surface 20 to obtain the projection frame features in S01 may include:

S011b: fully lighting one display panel 10 and simultaneously lighting the panel pixels in the other display panels 10, line by line.

Multiple panel pixels in a same line may be arranged sequentially along the same direction. In other words, multiple panel pixels arranged sequentially along the same direction may be considered to be in a same line. After one display panel 10 is fully illuminated, when the panel pixels in the other display panels 10 are illuminated line by line, overlapping projection pixels 201 may be displayed line by line.

S012b: capturing the images of the projection frame 200 of the images displayed by each display panel 10 on the target projection surface 20 at a first frequency to obtain the projection frame features.

The first frequency may be the frequency at which the panel pixels in the other display panels 10 may be illuminated line by line. That is, after one line of the panel pixels of the other display panels 10 is illuminated, an image of the projection frames 200 on the target projection surface 20 may be captured. As the other display panels 10 may be illuminated line by line, images of the projection pixels on the target projection surface 20 that change line by line may be captured, and the range of the pixel lines of overlapping projection pixels 201 may be determined based on the color changes of the images.

The panel pixels in one same line may be panel pixels in one same column or row. When information about overlapping and misalignment of projection pixels in the column direction may be needed, the panel pixels may be illuminated line by line, which may include illuminating the panel pixels row by row. When information about overlapping and misalignment of projection pixels in the row direction may be needed, the panel pixels may be illuminated line by line, which may include illuminating the panel pixels column by column.

The following explanation uses illuminating panel pixels column by column as an example of illuminating panel pixels line by line.

For example, as shown in FIG. 19, first the entire screen of the green display panel 10G may be lit up, such that the green projection frame 20R appears on the target projection surface 20. Then the first column of the red display panel 10R and the first column of the blue display panel 10B may be lit up to collect the image of the projection frame 200 on the target projection surface 20. At this time, the first column of the collected projection pixel image may be green, the second column may be green, the third column may be yellow, the fourth column may be white, and the fifth to eighth columns may be green. It can be inferred that the green projection frame 20G may be offset to the left by 2 columns of projection pixels relative to the red projection frame 20R, and the blue projection frame 20B may be offset to the right by 1 column of projection pixels relative to the red projection frame 20R. It can be inferred that the projection pixels in the fourth column to the eighth column of the green projection frame 20G may be overlapping projection pixels 201, the projection pixels in the second to the sixth columns of the red projection frame 20R may be overlapping projection pixels 201, and the projection pixels in the first to the fifth column of the blue projection frame 20B may be overlapping projection pixels 201. The projection pixels in the first to the third columns of the green projection frame 20G may be offset projection pixels 202, the projection pixels in the first, seventh, and eighth columns of the red projection frame 20R may be offset projection pixels 202, and the projection pixels in the sixth to the eighth columns of the blue projection frame 20B may be offset projection pixels 202.

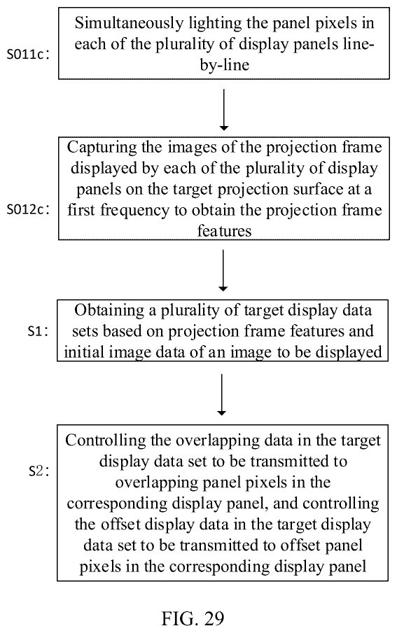

FIG. 29 is a flow chart of a frame alignment method of a display module provided by an embodiment of the present disclosure.

In the embodiment shown in FIG. 29, capturing the images of each projection frame 200 on the target projection surface 20 to obtain the projection frame features in S01 may include:

S011c: Simultaneously illuminate the panel pixels in each display panel 10, line by line.

The multiple panel pixels in one same line may be panel pixels arranged sequentially along the same direction. That is, the multiple panel pixels arranged sequentially along the same direction may be considered to be the same line of panel pixels.

S012c: capturing images of the projection frame 200 of the images displayed by each display panel 10 on the target projection surface 20 at a first frequency to obtain projection frame features.

The first frequency may be the frequency at which the panel pixels in the display panel 10 are illuminated line by line. That is, after each display panel 10 illuminates one line simultaneously, the image of the projection frame 200 on the target projection surface 20 may be captured once. As the display panels 10 may be illuminated line by line, images of the projection pixels on the target projection surface 20 may be captured, and the range of the pixel lines with overlapping projection pixels 201 may be determined based on the color changes of the images.

The panel pixels in one same line can be panel pixels in one same column or row. When information of overlap and misalignment of projection pixels in the column direction is required, the panel pixels may be illuminated line by line, which may include illuminating the panel pixels row by row. When it is necessary to obtain information about overlap and misalignment of projection pixels in the row direction, the panel pixels may be illuminated line by line, which may include illuminating the panel pixels column by column.

The following explanation uses illuminating panel pixels column by column as an example of illuminating panel pixels line by line.

For example, as shown in FIG. 19, first, the first column of the green display panel 10G, the first column of the red display panel 10R, and the first column of the blue display panel 10B may be illuminated, and an image of the projection frame 200 on the target projection surface 20 may be captured. The captured image of the projection pixels may include one column of green, one column of red, and one column of blue. Then, the second column of the green display panel 10G, the second column of the red display panel 10R, and the second column of the blue display panel 10B may be illuminated, and an image of the projection frame 200 on the target projection surface 20 may be captured. At this point, in the captured image of projection pixels, the first column may be green, the second column may be green, the third column may be red, the fourth column may be purple, and the fifth column may be blue. Then, the third column of the green display panel 10G, the third column of the red display panel 10R, and the third column of the blue display panel 10B may be illuminated, and an image of the projection frame 200 on the target projection surface 20 may be captured. At this point, in the captured image of projection pixels, the first column may be green, the second column may be green, the third column may be yellow, the fourth column may be purple, the fifth column may be purple, and the sixth column may be blue. It can be inferred that the green projection frame 20G may be offset to the left by two columns of projection pixels relative to the red projection frame 20R, and that the blue projection frame 20B may be offset to the right by one column of projection pixels relative to the red projection frame 20R. It can be inferred that the projection pixels in the 4th to 8th columns of the green projection frame 20G may be overlapping projection pixels 201, the projection pixels in the 2nd to 6th columns of the red projection frame 20R may be overlapping projection pixels 201, and the projection pixels in the 1st to 5th columns of the blue projection frame 20B may be overlapping projection pixels 201. The projection pixels in the 1st to 3rd columns of the green projection frame 20G may be offset projection pixels 202, the projection pixels in the 1st, 7th and 8th columns of the red projection frame 20R may be offset projection pixels 202, and the projection pixels in the 6th to 8th columns of the blue projection frame 20B may be offset projection pixels 202.

By lighting at least one display panel 10 line by line and capturing the image of the projection frame 200 on the target projection surface 20 at the first frequency, the position coordinates of the overlapping projection pixels 201 and the offset projection pixels may be inferred based on color changes and the number of captures.

It should be noted that the above description uses lighting up the panel pixels column by column as an example of lighting up the panel pixels line by line. When the panel pixels need to be lit up row by row to obtain information about the overlap and misalignment of the projection pixels in the column direction, a similar column-by-column lighting method can be adopted, but the lighting may be done line by line in different directions.

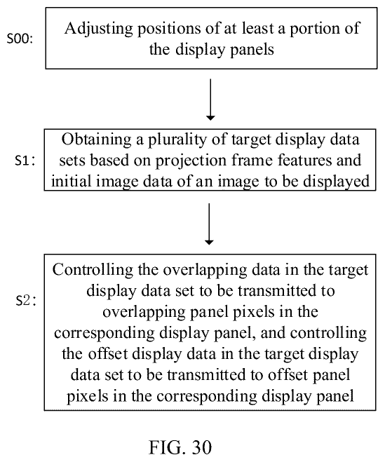

FIG. 30 is a flow chart of a frame alignment method of a display module provided by an embodiment of the present disclosure.

In the embodiment shown in FIG. 30, the frame alignment method of the display module 01 may further include:

S00: adjusting the position of at least a portion of the display panels 10.

It can be understood that the methods provided in the previous embodiments of the present disclosure fine-tune the projection frame of the display module 01. The adjustment of the panel position in this embodiment may be considered a coarse adjustment of the projection frames of the display module 01. This coarse adjustment may minimize the misalignment between different projection frames 200 on the target projection surface 20, thereby avoiding excessive image loss after fine-tuning.

Based on this embodiment, the display module provided in the present disclosure may have a coarse adjustment function. For example, in response to user operation, the mechanical structure of the display module may be used to control the position of the display panels.

In one embodiment, S00 can be performed before S01.

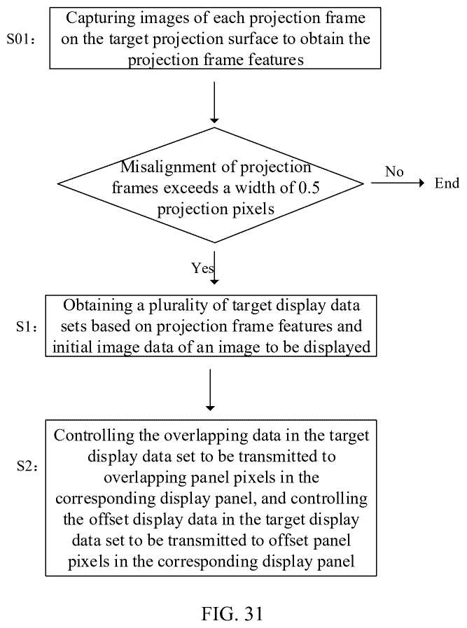

FIG. 31 is a flow chart of a frame alignment method of a display module provided by an embodiment of the present disclosure.

In the embodiment shown in FIG. 31, the frame alignment method of the display module 01 may further include:

S02: based on projection frame features, determining whether the misalignment of different projection frames 200 on the target projection surface 20 along a first direction exceeds a width of 0.5 projection pixels; and

S1: when the misalignment exceeds a width of 0.5 projection pixels, capturing the multiple target display data sets based on the projection frame features and the initial image data D0 of the to-be-displayed image IM.

That is, before fine-tuning the projection frames 200 of the display module 01, it may be determined, based on the projection frame features, whether fine-tuning is necessary. In this embodiment, when the misalignment of different projection frames 200 on the target projection surface 20 along the first direction exceeds a width of 0.5 projection pixels, fine-tuning may be performed; otherwise, the screen alignment process may be terminated without fine-tuning.

It should be noted that when multiple projected pixels representing one same pixel in the image IM to be displayed overlap to achieve color mixing, the projected pixels representing the same pixel in the image IM to be displayed may be considered non-overlapping if their offset in the first direction exceeds a width of 0.5 projected pixels. This means that the projected images 200 may be offset in the first direction on the target projection surface 20 by more than a width of 0.5 projected pixels. When multiple projected pixels representing the same pixel in the image IM to be displayed are separated by a preset distance to achieve color mixing, the projected pixels representing the same pixel in the image IM to be displayed may be considered non-overlapping if their distance is larger than the preset distance by a width of 0.5 projected pixels. This means that the projected images 200 may be offset in the first direction on the target projection surface 20 by more than a width of 0.5 projected pixels.

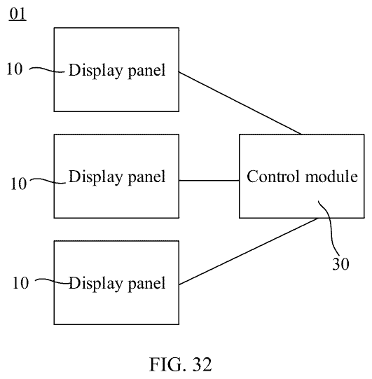

The present disclosure provides a display module. In one embodiment shown in FIG. 32, which is a schematic diagram of a display module provided by the present disclosure, the display module 01 may include multiple display panels 10 and a control module 30. The control module 30 may be configured to execute the frame alignment method provided by any of the aforementioned embodiments, to achieve alignment control of projection frames 200 of the display module 01.

As shown in FIG. 1, one embodiment of the present disclosure provides a display module 01 including multiple display panels 10. The display images of the display panels 10 may be projected onto a target projection surface 20 to present corresponding projection frames 200. The relationship between the panel pixels in the display panels 10 and the projection pixels in the projection frames 200 are described in the aforementioned embodiments and will not be repeated here. When the misalignment of at least two projection frames along the first direction on the target projection surface exceeds a preset value, the overlapping panel pixels 101 in different display panels 10 may display the same image and the offset panel pixels 102 in different display panels 10 may display the first grayscale image. The overlapping panel pixels 101 in the display panel 10 may correspond to the overlapping projection pixels 201 in the projection frames 200 that overlap with other projection frames 200, and the offset panel pixels 102 in the display panel 10 may correspond to the offset projection pixels 202 in the projection frame 200 that are offset with at least one other projection frame 200.

For example, as shown in FIG. 2 and FIG. 4, the overlapping panel pixels 101 in each display panel 10 may be all used to display the images corresponding to the pixels in the first to seventh columns of the image IM to be displayed. Accordingly, the different projection frames 200 on the target projection surface 20 may all display the same image. Further, the offset panel pixels 102 in each display panel 10 may be all used to display the same grayscale image.

In one embodiment of the present disclosure, as shown in FIG. 4, the first grayscale image may be a black image. That is, the offset panel pixels 102 in each display panel 10 may be all used to display a black image. Accordingly, each offset projection pixel 202 on the target projection surface 20 may display the black image.

Alternatively, in some other embodiments, the first grayscale image may also be other images. For example, the first grayscale image displayed by one offset panel pixel 102 may be the same as or similar to the image displayed by its adjacent overlapping panel pixel 101. Assuming the projection frame features shown in FIG. 2, the first grayscale image displayed by the leftmost offset panel pixel 102 in the red display panel 10R may be the same as the image displayed by the second column of panel pixels from the left (the overlapping panel pixels 101). The first grayscale image displayed by the rightmost offset panel pixel 102 in the green display panel 10G may be the same as the image displayed by the second column of panel pixels from the right (the overlapping panel pixels 101). The first grayscale image displayed by the rightmost offset panel pixel 102 in the blue display panel 10B may be the same as the image displayed by the second column of panel pixels from the right (the overlapping panel pixels 101).

In one embodiment of the present disclosure, the display module 01 may include a first color display panel 10G, a second color display panel 10R, and a third color display panel 10B. The first color display panel 10G may include 1st to L-th lines of first color panel pixels arranged along the second direction, the second color display panel 10R may include 1st to L-th lines of second color panel pixels arranged along the third direction, and the third color display panel 10B may include 1st to L-th lines of third color panel pixels arranged along the fourth direction.

Panel pixels in one same row may be panel pixels in one same column or row. The following explanation uses the example of panel pixels in the same line being panel pixels in the same column.

For example, the first color display panel 10G may be a green display panel 10G and may include green panel pixels in the first to eighth columns arranged along the second direction, the second color display panel 10R may be a red display panel 10R and may include red panel pixels in the first to eighth columns arranged along the third direction, and the third color display panel 10B may be a blue display panel 10B and may include blue panel pixels in the first to eighth columns arranged along the fourth direction.

In the first direction parallel to the target projection surface 20, the first color projection frame 20G and the third color projection frame 20B may both be offset by n projection pixels to the first projection orientation relative to the second color projection frame 20R. The first color projection frame 20G may be the projection of the screen displayed by the first color display panel 10G on the target projection surface 20, the second color projection frame 20R may be the projection of the screen displayed by the second color display panel 10R on the target projection surface 20, and the third color projection frame 20B may be the projection of the screen displayed by the third color display panel 10B on the target projection surface 20. For example, as shown in FIG. 4, the second color projection frame 20R may be a red projection frame 20R, the first color projection frame 20G may be a green projection frame 20G, and the third color projection frame 20B may be a blue projection frame 20B. Both the green projection frame 20G and the blue projection frame 20B may be offset to the right by one projection pixel relative to the red projection frame 20R on the target projection surface 20. That is, both the green projection frame 20G and the blue projection frame 20B may be offset to the right relative to the red projection frame 20R, and the offset width may be substantially equal to the width of one projection pixel.

The projections of the second, third, and fourth directions on the target projection surface 20 may be the same as the projections of the first direction. For example, as shown in FIG. 1, the light-emitting surfaces of the multiple display panels 10 included in the display module 01 may not be in the same plane. However, the projection frames 200 of the display images of these display panels 10 on the target projection surface 20 may be in the same plane. As shown in FIG. 1, FIG. 2, and FIG. 4, the image displayed by the first color panel pixels arranged in the first to L-th columns along the second direction may be projected onto the target projection surface 20 to form the image displayed by the first color panel pixels arranged in the first to L-th columns along the first direction. It may be understood that the projection of the second direction onto the target projection surface 20 may be the same as the projection of the first direction. Correspondingly, the projections of the third and fourth directions onto the target projection surface 20 may be the same as the projection of the first direction.

Furthermore, the first projection orientation may be the same as the first direction. That is, if the first projection orientation is right, the first direction may point from left to right.

In the first color display panel 10G, the first color panel pixels from the 1st to the (L−n)-th lines arranged along the second direction may be overlapping panel pixels 101, and the first color panel pixels from the (L−n+1)-th to the L-th lines may be offset panel pixels 102. In the second color display panel 10R, the second color panel pixels from the (n+1)-th to the L-th lines arranged along the third direction may be overlapping panel pixels 101, and the second color panel pixels from the 1st to the n-th lines may be offset panel pixels 102. In the third color display panel 10B, the third color panel pixels from the 1st to the (L−n)-th lines arranged along the fourth direction may be overlapping panel pixels 101, and the third color panel pixels from the (L−n+1)-th to the L-th lines may be offset panel pixels 102.

That is, the first to (L−n)-th lines of first color panel pixels arranged along the second direction, the (n+1)-th to (L)-th lines of second color panel pixels arranged along the third direction, and the first to (L−n)-th lines of third color panel pixels arranged along the fourth direction, may all display the same image to be displayed for displaying the image IM to be displayed.

For example, as shown in FIGS. 4, n=1 and L=8, then L−n=7 and n+1=2. The first to seventh rows of green panel pixels arranged along the second direction, the second to eighth rows of red panel pixels arranged along the third direction, and the first to seventh rows of blue panel pixels arranged along the fourth direction, may all display the image corresponding to the first to seventh rows of pixels in the image IM to be displayed. Therefore, the overlapping projection pixels 201 in each projection frame 200 on the target projection surface 20 may display the image corresponding to the first to seventh rows of pixels in the image IM to be displayed.

In one embodiment shown in FIG. 2 and FIG. 6, the first color panel pixels from the first to the (L−n)-th lines arranged along the second direction of the first color display panel 10G, the second color panel pixels from the (n+1)-th to the (L−n)-th lines arranged along the third direction of the second color display panel 10R, and the third color panel pixels from the first to the (L−n)-th lines arranged along the fourth direction of the third color display panel 10B, may all display the (n+1)-th to the (L−n)-th lines of images of the to-be-displayed image IM.

For example, as shown in FIGS. 4, n=1 and L=8, then L−n=7 and n+1=2. The green panel pixels from the first to the seventh columns arranged along the second direction, the red panel pixels from the second to the eighth columns arranged along the third direction, and the blue panel pixels from the first to the seventh columns arranged along the fourth direction, may all display the images corresponding to the pixels from the second to the eighth columns of the to-be-displayed image IM. Therefore, the overlapping projection pixels 201 in each projection frame 200 on the target projection surface 20 may display the images corresponding to the 2nd through 8th columns of pixels in the to-be-displayed image IM.

In one embodiment, as shown in FIG. 2, FIG. 4, and FIG. 8, the 1st through (L−n)-th lines of first color panel pixels arranged along the second direction in the first color display panel 10G, the (n+1)-th through L-th lines of second color panel pixels arranged along the third direction in the second color display panel 10R, and the 1st through (L−n)-th lines of third color panel pixels arranged along the fourth direction in the third color display panel 10B, may all display the 1st through (L−n)-th lines of images of the to-be-displayed image IM.

For example, as shown in FIGS. 4, n=1 and L=8, then L−n=7 and n+1=2. The green panel pixels arranged in the first through seventh columns along the second direction, the red panel pixels arranged in the second through eighth columns along the third direction, and the blue panel pixels arranged in the first through seventh columns along the fourth direction may be all used to display the image corresponding to the pixels in the first through seventh columns of the image IM to be displayed. Therefore, the overlapping projection pixels 201 in each projection frame 200 on the target projection surface 20 may display the image corresponding to the pixels in the first through seventh columns of the image IM to be displayed.

It should be noted that the above description of the display scheme for each color display panel is based on the example of projection frames with different colors with misalignment of projection pixel columns in the row direction. It may be understood that the technical solution of this embodiment may also be used to determine the display scheme for each color display panel when the projection frame has a misalignment of projection pixel rows in the column direction, which will not be further described.

In one embodiment of the present disclosure, the display module 01 may include a first color display panel 10G, a second color display panel 10R, and a third color display panel 10B. The first color display panel 10G may include first to L-th lines of first color panel pixels arranged along a second direction, the second color display panel 10R may include first to L-th lines of second color panel pixels arranged along a third direction, and the third color display panel 10B may include first to L-th lines of third color panel pixels arranged along a fourth direction.

Panel pixels in one same line may be located in one same column or row. The following description uses the example of panel pixels in the same line being in the same column.

For example, the first color display panel 10G may be a green display panel 10G, and the green display panel 10G may include green panel pixels arranged in the first to eighth columns along the second direction. The second color display panel 10R may be a red display panel 10R, and the red display panel 10R may include red panel pixels arranged in the first to eighth columns along the third direction. The third color display panel 10B may be a blue display panel 10B, and the blue display panel 10B may include blue panel pixels arranged in the first to eighth columns along the fourth direction.

In the first direction parallel to the target projection surface 20, the second color projection frame 20R may be offset by n projection pixels toward the first projection orientation relative to the first color projection frame 20G, and the third color projection frame 20B may be offset by m projection pixels toward the first projection orientation relative to the second color projection frame 20R. The first color projection frame 20G may be the projection of the image displayed by the first color display panel 10G on the target projection surface 20, the second color projection frame 20R may be the projection of the image displayed by the second color display panel 10R on the target projection surface 20, and the third color projection frame 20B may be the projection of the image displayed by the third color display panel 10B on the target projection surface 20. For example, as shown in FIG. 12, the second color projection frame 20R may be a red projection frame 20R, the first color projection frame 20G may be a green projection frame 20G, and the third color projection frame 20B may be a blue projection frame 20B. The red projection frame 20R may be offset to the right by one projection pixel relative to the blue projection frame 20G on the target projection surface 20, and the blue projection frame 20B may be offset to the right by one projection pixel relative to the red projection frame 20R on the target projection surface 20. That is, the red projection frame 20R may be offset to the right by a width substantially equal to the width of one projection pixel relative to the blue projection frame 20G, and the blue projection frame 20B may be offset to the right by a width substantially equal to the width of one projection pixel relative to the red projection frame 20R.

The projections of the second, third, and fourth directions on the target projection surface 20 may be the same as those of the first direction. For example, as shown in FIG. 1, the light-emitting surfaces of the multiple display panels 10 included in the display module 01 may not be in the same plane. However, the projection frames 200 of the display images of these display panels 10 on the target projection surface 20 may be in the same plane. As shown in FIG. 1 and FIG. 12, the image displayed by the first color panel pixels arranged in the first to L-th columns along the second direction may be projected onto the target projection surface 20 to form the image displayed by the first color panel pixels arranged in the first to L-th columns along the first direction. It may be understood that the projection of the second direction on the target projection surface 20 may be the same as that of the first direction. Correspondingly, the projections of the third and fourth directions on the target projection surface 20 may be the same as those of the first direction.

Furthermore, the first projection orientation and the first direction may be aligned in the same direction. That is, when the first projection orientation is right, the first direction may point from left to right.

In the first color display panel 10G, the (n+m+1)-th to L-th lines of first color panel pixels arranged along the second direction may be overlapping panel pixels 101, and the 1st to (n+m)-th lines of first color panel pixels may be offset panel pixels 102. In the second color display panel 10R, the (m+1)-th to (L−n)-th lines of second color panel pixels arranged along the third direction may be overlapping panel pixels 101, and the (L−n+1)-th to L-th lines of first color panel pixels may be offset panel pixels 102. In the third color display panel 10B, the 1 st to (L−n−m)-th lines of third color panel pixels arranged along the fourth direction may be overlapping panel pixels 101, and the 1st to (L−n−m+1)-th lines of third color panel pixels may be offset panel pixels 102.

That is, the (n+m+1)-th to L-th lines of first color panel pixels arranged along the second direction, the (m+1)-th to (L−n)-th lines of second color panel pixels arranged along the third direction, and the 1st to (L−n−m)-th lines of third color panel pixels arranged along the fourth direction, may display the same image to be displayed.

For example, as shown in FIG. 12 n=1, m=1, and L=8, then n+m+1=3, m+1=2, L−n=7, and L−n−m=6. The 3rd to 8th columns of green panel pixels arranged along the second direction, the 2nd to 7th columns of red panel pixels arranged along the third direction, and the 1st to 6th columns of blue panel pixels arranged along the fourth direction, may be all used to display images corresponding to the same six columns of pixels in the image to be displayed. Therefore, the overlapping projection pixels 201 in each projection frame 200 on the target projection surface 20 may display images corresponding to the same six columns of pixels in the image to be displayed.

In one embodiment shown in FIG. 12 and FIG. 13, the (n+m+1)-th to (L)-th lines of first color panel pixels arranged along the second direction in the first color display panel 10G, the (m+1)-th to (L−n)-th lines of second color panel pixels arranged along the third direction in the second color display panel 10R, and the 1st to (L−n−m)-th lines of third color panel pixels arranged along the fourth direction in the third color display panel 10B, may all display the (m+1)-th to (L−n)-th lines of images of the image IM to be displayed.

For example, as shown in FIGS. 13, n=1, m=1, and L=8, then n+m+1=3, m+1=2, L−n=7, and L−n−m=6. The third to eighth columns of green panel pixels arranged along the second direction, the second to seventh columns of red panel pixels arranged along the third direction, and the first to sixth columns of blue panel pixels arranged along the fourth direction, may be all used to display the images corresponding to the second to seventh columns of pixels in the image IM to be displayed. Therefore, the overlapping projection pixels 201 in each projection frame 200 on the target projection surface 20 may display the images corresponding to the second to seventh columns of pixels in the image IM to be displayed.

In one embodiment shown in FIG. 12 and FIG. 15, the (n+m+1)-th to L-th lines of first color panel pixels arranged along the second direction in the first color display panel 10G, the (m+1)-th to (L−n)-th lines of second color panel pixels arranged along the third direction in the second color display panel 10R, and the 1st to (L−n−m)-th lines of third color panel pixels arranged along the fourth direction in the third color display panel 10B, may all display the (n+m+1)-th to L-th lines of images of the image IM to be displayed.

For example, as shown in FIGS. 15, n=1, m=1, and L=8, then n+m+1=3, m+1=2, L−n=7, and L−n−m=6. The third to eighth columns of green panel pixels arranged along the second direction, the second to seventh columns of red panel pixels arranged along the third direction, and the first to sixth columns of blue panel pixels arranged along the fourth direction, may be all used to display the images corresponding to the second to seventh columns of pixels in the image IM to be displayed. Therefore, the overlapping projection pixels 201 in each projection frame 200 on the target projection surface 20 may display the images corresponding to the third to eighth columns of pixels in the image IM to be displayed.

In one embodiment shown in FIG. 12 to FIG. 17, the (n+m+1)-th to L-th lines of first color panel pixels arranged along the second direction in the first color display panel 10G, the (m+1)-th to (L−n)-th lines of second color panel pixels arranged along the third direction in the second color display panel 10R, and the 1st to (L−n−m)-th lines of third color panel pixels arranged along the fourth direction in the third color display panel 10B, may all display the 1st to (L−n−m)-th lines of images of the image IM to be displayed.

For example, as shown in FIGS. 17, n=1, m=1, and L=8, then n+m+1=3, m+1=2, L−n=7, and L−n−m=6. The third to eighth columns of green panel pixels arranged along the second direction, the second to seventh columns of red panel pixels arranged along the third direction, and the first to sixth columns of blue panel pixels arranged along the fourth direction, may be all used to display the image corresponding to the second to seventh columns of pixels in the image IM to be displayed. Therefore, the overlapping projected pixels 201 in each projection frame 200 on the target projection surface 20 may display the image corresponding to the first to sixth columns of pixels in the image IM to be displayed.

It should be noted that the above description uses the example of projected images of different colors with offset projection pixel columns in the row direction to illustrate the display scheme for each color display panel. It may be understandable that the technical solution of this embodiment may also be used to determine the display scheme of the display screen of each color display panel when there may be a misalignment of the projection pixel rows in the column direction of the projection frames of different colors, which will not be described in detail.

Each display panel 10 may include 1st to L-th lines of panel pixels arranged along a first panel direction. The projection of the first panel direction on the target projection surface 20 may be the same as the first direction. For example, the display module 01 may include a green display panel 10G, a red display panel 10R, and a blue display panel 10B. The green display panel 10G may include the 1st to 8th columns of green panel pixels arranged along a second direction, the red display panel 10R may include the 1st to 8th columns of red panel pixels arranged along a third direction, and the blue display panel 10B may include the 1st to 8th columns of blue panel pixels arranged along a fourth direction. The projection of the second direction on the target projection surface 20 may be the same as the first direction, the projection of the third direction on the target projection surface 20 may be the same as the first direction, and the projection of the fourth direction on the target projection surface 20 may be the same as the first direction. Therefore, the second direction, the third direction, and the fourth direction may be the first panel direction of the green display panel 10G, the first panel direction of the red display panel 10R, and the first panel direction of the blue display panel 10B, respectively.

When the number of lines of the offset projection pixels 202 along the first direction for all projection frames 200 on the target projection surface 20 is larger than or equal to two, the overlapping panel pixels 101 in each display panel 10 may display images from the i-th to the (L−j)-th lines of the to-be-displayed image IM, where i may be larger than or equal to 2 and j may be larger than or equal to 1.

For example, as shown in FIG. 13, the red projection frame 20R may be offset to the right by one projection pixel relative to the green projection frame 20G on the target projection surface 20, and the blue projection frame 20B may be offset to the right by one projection pixel relative to the red projection frame 20R on the target projection surface 20. Therefore, the number of offset projection pixel columns 202 along the first direction for all projection frames 200 on the target projection surface 20 may be equal to two. At this point, the overlapping panel pixels 101 in each display panel 10 may display images from the 2nd to the 7th columns of the to-be-displayed image IM, i.e., i=2, j=1, L=8, and 8−1=7.

For another example, as shown in FIG. 20, the red projection frame 20R may be offset to the right by two projection pixels relative to the green projection frame 20G on the target projection surface 20, and the blue projection frame 20B may be offset to the right by one projection pixel relative to the red projection frame 20R on the target projection surface 20. Therefore, the number of columns of offset projection pixels 202 along the first direction for all projection frames 200 on the target projection surface 20 may be equal to three. At this point, the overlapping panel pixels 101 in each display panel 10 may display the third through seventh columns of the image IM to be displayed, i.e., i=3, j=1, L=8, and 8−1=7.

It should be noted that the above description of the display scheme for each color display panel is based on the example of a misalignment of projection pixel columns in the row direction for projection frames of different colors. It may be understood that the technical solution of this embodiment may also be used to determine the display scheme for each color display panel when there is a misalignment of projection pixel rows in the column direction for projection frames of different colors. This will not be further described.

In one embodiment of the present disclosure, as shown in FIG. 23, when the misalignment of at least two projected images along a first direction on the target projection surface 20 exceeds a preset value, the resolution of the image IM to be displayed, as presented by the overlapping panel pixels in the display panel 10, may be lower than the resolution of the image IM to be displayed. In other words, the display module may downscale the image to be displayed and display it through the overlapping panel pixels in the display panel 10. Therefore, the user may see a relatively complete image to be displayed on the target projection surface 20.

It should be noted that FIG. 23 illustrates the reduction of the display resolution of the display panels 10 in the row direction by decimating pixel columns. In some embodiments, when there is a misalignment of projection pixel columns in the column direction between projected images of different colors, the display resolution of the display panel 10 in the column direction may also be reduced, for example, by decimating pixel rows.

In the technical solution provided in the embodiments of the present disclosure, the overlapping panel pixels in each display panel may display a same portion of the image to be displayed. Therefore, the overlapping projection pixels in each projection frame may display a same portion of the image to be displayed, which solves the blurring problem when the image to be displayed is displayed on the target projection surface.

In the present disclosure, relational terms such as “first” and “second” are only used to distinguish one entity or operation from another entity or operation, and do not necessarily require or imply that there is a relationship between these entities or operations. There is no such actual relationship or sequence. Furthermore, the terms “comprise”, “include”, or any other variations thereof are intended to cover a non-exclusive inclusion such that a process, method, article, or apparatus that may include a list of elements may include not only those elements, but also those not expressly listed, or elements inherent to the process, method, article or equipment. Without further limitation, an element defined by the statement “comprises a . . . ” does not exclude the presence of additional identical elements in a process, method, article, or apparatus that may include the stated element.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the disclosure. Thus, while the present disclosure has been described in detail with reference to the above described embodiments, the present disclosure is not limited to the above described embodiments, but may be embodied in other equivalent forms without departing from the scope of the present disclosure, which is determined by the appended claims.

What is claimed is:

1. A frame alignment method of a display module, the display module including a plurality of display panels which correspond one-to-one to a plurality of projection frames and one projection frame is a projection of a display image of one corresponding display panel to a target projection surface, the method comprising:
obtaining a plurality of target display data sets based on projection frame features and initial image data of an image to be displayed, wherein:
the projection frame features include projection pixel information of each projection frame overlapping and/or offset with other projection frames;
the plurality of target display data sets is respectively transmitted to corresponding display panels; and
each target display data set includes overlapping display data and offset display data, and the overlapping display data respectively included in different target display data sets corresponds to one same frame in the image to be displayed;
and
controlling the overlapping data in the target display data set to be transmitted to overlapping panel pixels in the corresponding display panel, and controlling the offset display data in the target display data set to be transmitted to offset panel pixels in the corresponding display panel, wherein the overlapping panel pixels in the display panel correspond to the overlapping projection pixels in the corresponding projection frame that overlap with other projection frames and the offset panel pixels in the display panel correspond to the offset projection pixels in the corresponding projection frame that are offset with at least one other projection frame.

2. The method according to claim 1, wherein:
obtaining the plurality of target display data sets based on the projection frame features and the initial image data of the image to be displayed includes:
reconstructing the initial image data of the image to be displayed based on the projection frame features to obtain target image data sets, wherein one target image data set includes overlapping image data and offset image data; and
converting the overlapping image data of the target image data set into the overlapping display data and converting the offset image data in the target image data set into the offset display data, to obtain the plurality of target display data sets.

3. The method according to claim 2, wherein:
reconstructing the initial image data of the image to be displayed based on the projection frame features to obtain the target image data sets includes:
determining reference image data sets and image data sets to be adjusted from the initial image data based on the projection frame features, wherein the reference image data sets include the overlapping image data;
selecting first-type image data to be adjusted from the image data sets to be adjusted, wherein the first-type image data to be adjusted and the overlapping image data in the reference image data sets correspond to one same frame in the image to be displayed; and
adjusting coordinates of the first-type image data to be adjusted to obtain the overlapping image data.

4. The method according to claim 3, wherein:
reconstructing the initial image data of the image to be displayed based on the projection frame features to obtain the target image data sets further includes:
selecting second-type image data to be adjusted from the image data sets to be adjusted, wherein the second-type image data to be adjusted includes image data in the image data sets to be adjusted other than the first-type image data to be adjusted;
adjusting grayscale values of the second-type image data to be adjusted to a first grayscale value and adjusting coordinates of the second-type of image data to be adjusted, to obtain the offset image data; and
adjusting grayscale values of the offset image data included in the reference image data sets to the first grayscale value, wherein the first grayscale value is grayscale 0.

5. The method according to claim 3, wherein:
the plurality of display panels in the display module includes a first color display panel, a second color display panel, and a third color display panel, wherein:
in a first direction parallel to the target projection surface, a second color projection frame is offset by n projection pixels toward a first projection orientation relative to a first color projection frame and a third color projection frame, wherein: the first color projection frame is a projection of a frame displayed by the first color display panel on the target projection surface, the second color projection frame is a projection of a frame displayed by the second color display panel on the target projection surface, and the third color projection frame is a projection of a frame displayed by the third color display panel on the target projection surface; and
determining the reference image data sets and the image data sets to be adjusted from the initial image data based on the projection frame features includes: based on the projection frame features, determining the initial image data corresponding to the second color projection frame as the reference image data sets, and determining the initial image data corresponding to the first color projection frame and the third color projection frame as the image data sets to be adjusted;
or,
the display module includes a first color display panel, a second color display panel and a third color display panel, wherein:
in a first direction parallel to the target projection surface, a second color projection frame is offset by n projection pixels toward a first projection orientation relative to a first color projection frame and a third color projection frame, wherein: the first color projection frame is a projection of a frame displayed by the first color display panel on the target projection surface, the second color projection frame is a projection of a frame displayed by the second color display panel on the target projection surface, and the third color projection frame is a projection of a frame displayed by the third color display panel on the target projection surface; and
determining the reference image data sets and the image data sets to be adjusted from the initial image data based on the projection frame features includes: based on the projection frame features, determining the initial image data corresponding to the second color projection frame as the image data sets to be adjusted, and determining the initial image data corresponding to the first color projection frame and the third color projection frame as the reference image data sets.

6. The method according to claim 3, wherein:
the display module includes a first color display panel, a second color display panel, and a third color display panel;
in a first direction parallel to the target projection surface, a second color projection frame is offset by n projection pixels toward a first projection orientation relative to a first color projection frame and a third color projection frame is offset by m projection pixels toward the first projection direction relative to the second color projection frame, wherein: the first color projection frame is a projection of a frame displayed by the first color display panel on the target projection surface, the second color projection frame is a projection of a frame displayed by the second color display panel on the target projection surface, and the third color projection frame is a projection of a frame displayed by the third color display panel on the target projection surface; and
determining the reference image data sets and the image data sets to be adjusted from the initial image data based on the projection frame features includes:
based on the projection frame features, determining the initial image data corresponding to the second color projection frame as the reference image data sets, and determining the initial image data corresponding to the first color projection frame and the third color projection frame as the image data sets to be adjusted; or
based on the projection frame features, determining the initial image data corresponding to the first color projection frame as the reference image data sets, and determining the initial image data corresponding to the second color projection frame and the third color projection frame as the image data sets to be adjusted; or
based on the projection frame features, determining the initial image data corresponding to the third color projection frame as the reference image data sets, and determining the initial image data corresponding to the first color projection frame and the second color projection frame as the image data sets to be adjusted.

7. The method according to claim 2, wherein:
reconstructing the initial image data of the image to be displayed based on the projection frame features to obtain target image data sets includes:
for each initial image data set, selecting first-type image data to be adjusted and second-type image data to be adjusted from the initial image data set, wherein: the first-type image data to be adjusted included in different initial image data sets corresponds to one same frame in the image to be displayed, the second-type image data to be adjusted include image data in the image data set to be adjusted other than the first-type image data, and the second-type image data to be adjusted in one same initial image data set is located on two sides of the first-type image data;
based on the projection frame features, adjusting the coordinates of the first-type image data to be adjusted to obtain the overlapping image data; and
adjusting the grayscale value of the second-type image data to be adjusted to the first grayscale value and adjusting the coordinates of the second-type image data to be adjusted, to obtain the offset image data.

8. The method according to claim 2, wherein:
reconstructing the initial image data of the image to be displayed based on the projection frame features to obtain target image data sets includes:
based on the projection frame features, compressing the initial image data of the image to be displayed to obtain the overlapping image data.

9. The method according to claim 1, wherein:
obtaining the plurality of target display data sets based on the projection frame features and the initial image data of the image to be displayed includes:
converting the initial image data of the image to be displayed into an initial display data set, wherein: the initial display data set includes initial overlapping display data converted from overlapping image data in the initial image data and initial offset display data converted from offset image data in the initial image data, and different overlapping image data in the initial image data correspond to one same image in the image to be displayed; and
based on the projection frame features, adjusting storage addresses of the initial overlapping display data in at least a portion of the initial display data set and adjusting storage addresses of the initial offset display data in at least a portion of the initial display data set to obtain the target display data.

10. The method according to claim 9, wherein:
converting the initial image data of the image to be displayed into the initial display data set includes:
deriving a data voltage for the initial overlapping display data based on the grayscale value of the overlapping image data in the initial image data; and
determining a data voltage for the initial offset display data as a first data voltage based on the offset image data in the initial image data.

11. The method according to claim 1, further comprising:
capturing images of each projection frame on the target projection surface to obtain the projection frame features.

12. The method according to claim 11, wherein:
capturing the images of each projection frame on the target projection surface to obtain the projection frame features includes:
fully lighting each display panel and capturing the images of the projection frames displayed by each display panel on the target projection surface to obtain the projection frame features; or
fully lighting one of the plurality of display panels and simultaneously lighting the panel pixels of other display panels line-by-line, wherein multiple panel pixels in one same line are arranged sequentially in one same direction; and capturing the images of the projection frame displayed by each of the plurality of display panels on the target projection surface at a first frequency to obtain the projection frame features, wherein the first frequency is a frequency at which the panel pixels of the other display panels are lit line-by-line; or
simultaneously lighting the panel pixels in each of the plurality of display panels line-by-line, wherein multiple panel pixels in one same line are arranged sequentially in one same direction; and capturing the images of the projection frame displayed by each of the plurality of display panels on the target projection surface at a first frequency to obtain the projection frame features, wherein the first frequency is a frequency at which the panel pixels of the plurality of display panels are lit line-by-line.

13. The method according to claim 1, further comprising:
adjusting positions of at least a portion of the display panels; or
based on projection frame features, determining whether the misalignment of different projection frames along a first direction on the target projection surface exceeds a width of 0.5 projection pixels; and when the misalignment exceeds a width of 0.5 projection pixels, obtaining the plurality of target display data sets based on the projection frame features and initial image data of the image to be displayed.

14. A display module, comprising:
a plurality of display panels which correspond one-to-one to a plurality of projection frames, wherein one projection frame is a projection of a display image of one corresponding display panel to a target projection surface; and
a control module, configured to:
obtain a plurality of target display data sets based on projection frame features and initial image data of an image to be displayed, wherein:
the projection frame features include projection pixel information of each projection frame overlapping and/or offset with other projection frames;
the plurality of target display data sets is respectively used to be transmitted to corresponding display panels; and
each target display data set includes overlapping display data and offset display data, and the overlapping display data respectively included in different target display data sets corresponds to one same frame in the image to be displayed;
and
control the overlapping data in the target display data set to be transmitted to overlapping panel pixels in the corresponding display panel, and control the offset display data in the target display data set to be transmitted to offset panel pixels in the corresponding display panel, wherein the overlapping panel pixels in the display panel correspond to the overlapping projection pixels in the corresponding projection frame that overlap with other projection frames and the offset panel pixels in the display panel correspond to the offset projection pixels in the corresponding projection frame that are offset with at least one other projection frame.

15. A display module, comprising a plurality of display panels, wherein:
a display image of one display panel is projected to a target projection surface to present a corresponding projection frame;
when misalignment of at least two projection frames along a first direction on the target projection surface exceeds a preset value, overlapping panel pixels in different display panels display one same frame and the misaligned panel pixels in different display panels display a first grayscale image;
the overlapping panel pixels in one display panel correspond to overlapping projection pixels in one corresponding projection frame that overlap with other projection frames, and the misaligned panel pixels in the display panel correspond to misaligned projection pixels in the corresponding projection frame that are misaligned with at least one other projection frame, wherein the first grayscale image is a black image.

16. The display module according to claim 15, wherein:
the plurality of display panels in the display module includes a first color display panel, a second color display panel and a third color display panel;
the first color display panel includes a first line to an L-th line of first color panel pixels arranged along a second direction;
the second color display panel includes a first line to an L-th line of second color panel pixels arranged along a third direction;
the third color display panel includes a first line to an L-th line of third color panel pixels arranged along a fourth direction;
in a first direction parallel to the target projection surface, a first color projection frame and a third color projection frame are both offset by n projection pixels toward a first projection direction relative to the second color projection frame, wherein: the first color projection frame is a projection of a frame displayed by the first color display panel to the target projection surface, the second color projection frame is a projection of a frame displayed by the second color display panel to the target projection surface, and the third color projection frame is a projection of a frame displayed by the third color display panel to the target projection surface;
projections of the second direction, the third direction, and the fourth direction on the target projection surface are the same as the first direction;
in the first color display panel, the first color panel pixels of the 1st to (L−n)-th lines arranged along the second direction are overlapping panel pixels, and the first color panel pixels of the (L−n+1)-th to L-th lines are offset panel pixels;
in the second color display panel, the second color panel pixels of the (n+1)-th to L-th lines arranged along the third direction are overlapping panel pixels, and the second color panel pixels of the 1st to n-th lines are offset panel pixels; and
in the third color display panel, the third color panel pixels of the 1st to (L−n)-th lines arranged along the fourth direction are overlapping panel pixels, and the third color panel pixels of the (L−n+1)-th to L-th lines are offset panel pixels.

17. The display module according to claim 16, wherein:
the first color panel pixels from the 1st line to the (L−n)-th line arranged along the second direction in the first color display panel, the second color panel pixels from the (n+1)-th line to the L-th line arranged along the third direction in the second color display panel, and the third color panel pixels from the 1st line to the (L−n)-th line arranged along the fourth direction in the third color display panel, all display frames of the (n+1)-th line to the L-th line in the image to be displayed; or
the first color panel pixels from the 1st line to the (L−n)-th line arranged along the second direction in the first color display panel, the second color panel pixels from the (n+1)-th line to the L-th line arranged along the third direction in the second color display panel, and the third color panel pixels from the 1st line to the (L−n)-th line arranged along the fourth direction in the third color display panel, all display frames of the first to (L−n)-th lines of images to be displayed.

18. The display module according to claim 15, wherein:
the plurality of display panels in the display module includes a first color display panel, a second color display panel and a third color display panel;
the first color display panel includes a first line to an L-th line of first color panel pixels arranged along a second direction;
the second color display panel includes a first line to an L-th line of second color panel pixels arranged along a third direction;
the third color display panel includes a first line to an L-th line of third color panel pixels arranged along a fourth direction;
in a first direction parallel to the target projection surface, a second color projection frame is offset by n projection pixels toward a first projection direction relative to a first color projection frame and a third color projection frame is offset by m projection pixels toward the first projection direction relative to the second color projection frame, wherein: the first color projection frame is a projection of a frame displayed by the first color display panel to the target projection surface, the second color projection frame is a projection of a frame displayed by the second color display panel to the target projection surface, and the third color projection frame is a projection of a frame displayed by the third color display panel to the target projection surface;
projections of the second direction, the third direction, and the fourth direction on the target projection surface are the same as the first direction;
in the first color display panel, the first color panel pixels of the (n+m+1)-th to L-th lines arranged along the second direction are overlapping panel pixels, and the first color panel pixels of the 1st to (n+m)-th lines are offset panel pixels;
in the second color display panel, the second color panel pixels of the (m+1)-th to (L−n)-th lines arranged along the third direction are overlapping panel pixels, and the second color panel pixels of the (L−n+1)-th to L-th lines are offset panel pixels; and
in the third color display panel, the third color panel pixels of the 1st to (L−n−m)-th lines arranged along the fourth direction are overlapping panel pixels, and the third color panel pixels of the (L−n−m+1)-th to L-th lines are offset panel pixels.

19. The display module according to claim 18, wherein:
the first color panel pixels from the (n+m+1)-th line to the L-th line arranged along the second direction in the first color display panel, the second color panel pixels from the (m+1)-th line to the (L−n)-th line arranged along the third direction in the second color display panel, and the third color panel pixels from the 1st line to the (L−n−m)-th line arranged along the fourth direction in the third color display panel, all display frames of the (m+1)-th line to the (L−n)-th line in the image to be displayed; or
the first color panel pixels from the (n+m+1)-th line to the L-th line arranged along the second direction in the first color display panel, the second color panel pixels from the (m+1)-th line to the (L−n)-th line arranged along the third direction in the second color display panel, and the third color panel pixels from the 1st line to the (L−n−m)-th line arranged along the fourth direction in the third color display panel, all display frames of the (n+m+1)-th line to the L-th line in the image to be displayed; or
the first color panel pixels from the (n+m+1)-th line to the L-th line arranged along the second direction in the first color display panel, the second color panel pixels from the (m+1)-th line to the (L−n)-th line arranged along the third direction in the second color display panel, and the third color panel pixels from the 1st line to the (L−n−m)-th line arranged along the fourth direction in the third color display panel, all display frames of the 1st line to the (L−n−m)-th line in the image to be displayed.

20. The display module according to claim 15, wherein:
each of the plurality of display panels includes 1st to L-th lines of panel pixels arranged along a first panel direction, wherein a projection of the first panel direction on the target projection surface is the same as the first direction; and when the number of offset projection pixel lines along the first direction for all projected images on the target projection surface is larger than or equal to 2, the overlapping panel pixels in each of the plurality of display panels display images from the i-th to (L-j)-th lines of the image to be displayed, where i is larger than or equal to 2 and j is larger than or equal to 1; or
when the misalignment of at least two projection frames on the target projection surface along the first direction exceeds a preset value, the resolution of the image to be displayed presented by the overlapping panel pixels in the plurality of display panels is smaller than the resolution of the image to be displayed.
